(19) United States
(12) Patent Application Publication
(10) Pub. No.: US 2023/0256673 A1
(43) Pub. Date: Aug. 17, 2023

(54) SYSTEM AND METHOD FOR LASER BASED ADDITIVE MANUFACTURING

(71) Applicant: LARGIX TECH LTD., Tzur Yigal (IL)

(72) Inventors: Ronen ORR, Tel Mond (IL); Amir SHEELO, Raanana (IL); Hasdi MATARASSO, Pardes Chana (IL); Neria FIRSHTMAN, Rehovot (IL)

(73) Assignee: LARGIX TECH LTD., Tzur Yigal (IL)

(21) Appl. No.: 18/010,581

(22) PCT Filed: Jun. 15, 2021
(86) PCT No.: PCT/IL2021/050720

§ 371 Date: Dec. 15, 2022

Related U.S. Application Data
(60) Provisional application No. 63/039,148, filed on Jun. 15, 2020.

(51) Int. Cl. B29C 64/277; B29C 64/118; B29C 64/268; B29C 64/321; B33Y 10/00; B33Y 30/00

(52) U.S. Cl. CPC B29C 64/277; B29C 64/118; B29C 64/268; B29C 64/321; B33Y 10/00; B33Y 30/00

(57) ABSTRACT

Systems and methods of laser based additive manufacturing are provided, in which solid polymer material strands are continuously received and have their surfaces melted by laser source(s). Such a system may include a feeder configured to continuously feed, two or more solid polymer material strands, a first guiding unit comprising two or more conduits to continuously receive and guide the two or more solid polymer material strands from the feeder towards a connecting point, a first laser unit, comprising one or more laser sources, each source is directed to deliver a specified laser beam with respect to adjacent surfaces of two adjacent strands towards the connecting point.

### CROSS REFERENCE TO RELATED APPLICATIONS

This application is a PCT Patent Application which claims the benefit of priority under 35 U.S.C. § 119(e) of U.S. Provisional Application No. 63/039,148, filed on Jun. 15, 2020. The contents of the above applications are all incorporated by reference as if fully set forth herein in their entirety.

### TECHNICAL FIELD

The present invention relates to the field of additive manufacturing, and more particularly, to additive manufacturing using polymer materials and laser welding systems.

### BACKGROUND OF THE INVENTION

Historically, prototype development and customized manufacturing has been performed by traditional methods using metal extrusion, computer-controlled machining and manual modeling techniques, in which blocks of material are carved or milled into specific objects. These subtractive manufacturing methodologies have numerous limitations. They often require specialist technicians and can be time- and labor intensive. The time intensity of traditional modeling can leave little room for design errors or subsequent redesign without meaningfully affecting a product's time-to-market and development cost. As a result, prototypes have been created only at selected milestones late in the design process, which prevents designers from truly visualizing and verifying the design of an object in the preliminary design stage. The inability to iterate a design rapidly hinders collaboration among design team members and other stakeholders and reduces the ability to optimize a design, as time-to-market and optimization become necessary trade-offs in the design process.

Additive manufacturing (“AM”) addresses the inherent limitations of traditional modeling technologies through its combination of functionality, quality, and ease of use, speed and cost. AM is significantly more efficient and cost effective than traditional model-making techniques for use across the design process, from concept modeling and design review and validation, to fit and function prototyping, pattern making and tooling, to direct manufacturing of repeatable, cost-effective parts, short-run parts and customized end products.

Introducing 3D modeling earlier in the design process to evaluate fit, form and function can result in faster time-to-market and lower product development costs. For customized manufacturing, 3D printers eliminate the need for complex manufacturing set ups and reduce the cost and lead-time associated with conventional tooling. The first commercial 3D printers were introduced in the early 1990s, and since the early 2000s, 3D printing technology has evolved significantly in terms of price, variety and quality of materials, accuracy, ability to create complex objects, ease of use and suitability for office environments. 3D printing is already replacing traditional prototype development methodologies across various industries such as architecture, automotive, aerospace and defense, electronics, medical, footwear, toys, educational institutions, government and entertainment, underscoring its potential suitability for an even broader range of industries.

3D printing has created new applications for model-making in certain new market categories, such as: education, where institutions are increasingly incorporating 3D printing into their engineering and design course programs; dental and orthodontic applications, where 3D printed models are being used as replacements for traditional stone models, implants and surgical guides and for crowns and bridges for casting; Furthermore, 3D printing is being used in many industries for the direct digital manufacturing of end-use parts.

Accordingly, there is a need for new additive manufacturing process that will allow the production of large objects, such as, tanks and containers, from polymer strands.

### SUMMARY OF THE INVENTION

One aspect of the present invention provides an additive manufacturing system and method including: a feeder configured to feed, continuously, solid polymer material strands, wherein the polymer material absorbs a specified laser radiation, at least one tip configured to receive, continuously, the solid polymer material strands from the feeder, at least one laser source, configured to laser-weld the strands by heating at least a part of a surface of the continuously received solid polymer material strands peripherally—to liquefy the at least part of the surface, using specified heating-related parameters which are selected to maintain a central volume of the continuously received solid polymer material in a solid state, wherein the at least one laser source is positioned to deliver the specified laser radiation with respect to the surface parts of the strands, wherein the system is further configured to attach the strands at their peripherally heated surface parts, by a re-solidification of the liquefied parts of the surfaces to yield monolithic attachment.

Some aspects of the invention are related to an additive manufacturing system including: a feeder configured to continuously feed, two or more solid polymer material strands; a first guiding unit comprising two or more conduits to continuously receive and guide the two or more solid polymer material strands from the feeder towards a connecting point; a first laser unit, comprising one or more laser sources, each source is directed to deliver a specified laser beam with respect to adjacent surfaces of two adjacent strands towards the connecting point; and a first press configured to press the free surfaces, substantially parallel to the adjacent surfaces of the two or more strands to form a continuous solid strip.

In some embodiments, the system further includes: a second guiding unit configured to continuously direct the continuous solid strip to be attached to one of: a substrate and a previously manufactured continuous solid strip; a second laser unit, comprising one or more laser sources, each source is directed to deliver a specified laser beam with respect to adjacent surfaces of the continuous solid strip and one of: the substrate and the previously manufactured continuous solid strip; and a second press configured to press the continuous solid strip and one of the substrate and the previously manufactured continuous solid strip one to the other.

In some embodiments, the second press applies 0.1-10 bar. In some embodiments, the second press applies 0.5-500 N. In some embodiments, the one or more laser sources apply laser beams having 700-3500 nm wavelength. In some embodiments, the one or more laser sources apply laser beams having 900-1100 nm wavelength. In some embodiments, first press applies at least 0.1-10 bar. In some embodiments, the first press applies at least 0.5-500 N. In some embodiments, the two or more conduits are located such that the two or more strands are directed one toward the other at a predetermined angle of 2-80 deg.

In some embodiments, each one of the one or more laser sources applies laser beam at an intensity optimized to melt 20-500 microns of the surfaces of the solid polymer strands. In some embodiments, each one of the one or more laser sources applies laser beam at an intensity optimized to melt the adjacent surfaces of the solid polymer strands to a depth of 0.5-25% from a dimension of each strand perpendicular to the adjacent surface.

In some embodiments, the feeder is configured to continuously feed two or more solid polymer material strands at a feeding velocity optimized to allow the laser beams to melt 20-500 microns of the surface of the solid polymer strands. In some embodiments, the feeder is configured to continuously feed the two or more solid polymer material strands at a feeding velocity optimized to allow the laser beams to melt the adjacent surfaces of the solid polymer strands to a depth of 0.5-25% from a dimension of each strand perpendicular to the adjacent surface.

Some additional aspects of the invention are directed to a method for additive manufacturing including: providing at least two solid polymer strands guided towards a connecting point of adjacent surfaces of each two strands; and continuously directing and delivering at least one first specified laser beam towards each connecting point, using a first laser unit, comprising one or more laser sources; melting portions of the adjacent surfaces of each two adjacent strands; and continuously pressing free surfaces, substantially parallel to the melted adjacent surfaces of the two or more strands, to bond the melted adjacent surfaces to form a solid strip, using a first press.

In some embodiments, providing at least two adjacent strands may include: continuously feeding, by a feeder, two or more solid polymer material strands; and continuously receiving and guiding the two or more solid polymer material strands from the feeder using a first guiding unit comprising two or more conduits. In some embodiments, providing at least two adjacent strands may include: placing a first solid polymer material strand with respect to a second solid polymer material strand. In some embodiments, pressing the free surface of the two or more strands to form the solid strip, using the first press is conducted from two sides of the continuous solid strip.

In some embodiments, the method further includes: continuously directing the continuous solid strip to be attached to a one of: a substrate and previously manufactured continuous solid strip, using a second guiding unit; directing and delivering at least one second specified laser beam with respect to adjacent surfaces of the continuous solid strip and one of: the substrate and the previously manufactured continuous solid strip, using a second laser unit, comprising one or more laser sources; melting portions of the adjacent surfaces of the strip and one of: the substrate and the previously manufactured continuous solid strip; and pressing the continuous solid strip and one of: the substrate and the previously manufactured continuous solid strip, one to the other, using a second press, to form 3D object. In some embodiments, pressing the continuous solid strip and one of the substrate and the previously manufactured continuous solid strip, one to another is by applying pressing force on at least one free surface of the continuous solid strip.

In some embodiments, the at least two strands are made from polyethylene or polypropylene. In some embodiments, the two or more solid polymer material strands comprises polymer material comprising laser absorbing additive. In some embodiments, a first strand from the at least two strands is made from a first type of polymer and a second strand from the at least two strands is made from a second type of polymer.

In some embodiments, the feeding is conducted at 0.1-1500 mm/sec. In some embodiments, melting portions of the adjacent surfaces of each two adjacent strands is to a depth of 0.5-25% from a dimension of each strand perpendicular to the adjacent surface. In some embodiments, melting the adjacent surfaces of each two adjacent strands is to a depth of 20-500 microns.

Additional aspects of the invention include an additive manufacturing system including: a feeder configured to continuously feed, a solid polymer material strand; a guiding unit comprising a conduit to continuously direct the solid polymer material strand to be attached to one of: a substrate and a previously provided solid polymer material strand; a laser unit, comprising one or more laser sources, each source is directed to deliver a specified laser beam towards a connecting point between adjacent surfaces of the solid polymer material strand and one of: the substrate and the previously provided solid polymer material strand; and a press configured to press at least one free surface, substantially parallel to the adjacent surfaces.

In some embodiments, the one or more laser sources apply laser beams having 700-3500 nm wavelength. In some embodiments, the one or more laser sources apply laser beams having 900-1100 nm wavelength. In some embodiments, each one of the one or more laser sources applies laser beam at an intensity optimized to melt 20-500 microns of the surface of the solid polymer strand. In some embodiments, each one of the one or more laser sources applies laser beam at an intensity optimized to melt the adjacent surfaces to a depth of 0.5-25% from a dimension of the strand perpendicular to the adjacent surface.

In some embodiments, the feeder is configured to continuously feed the solid polymer material strand at a feeding velocity optimized to allow the laser beams to melt 20-500 microns of the surface of the solid polymer strand. In some embodiments, the feeder is configured to continuously feed the solid polymer material strand at a feeding velocity optimized to allow the one or more laser beams to melt the adjacent surfaces to a depth of 0.5-25% from a dimension of the strand perpendicular to the adjacent surface.

In some embodiments, the press applies at least 0.1-10 bar. In some embodiments, the first press applies at least 0.5-500 N. In some embodiments, the feeder is configured to the direct the solid polymer material strand toward one of: the substrate and the previously provided solid polymer material strand at a predetermined angle of 2-80 deg.

Some additional aspects of the invention include a method for additive manufacturing including: providing a solid polymer strand guided towards a connecting point with one of: a substrate and a previously provided solid polymer material strand; continuously directing and delivering at least one specified laser beam towards the connecting point using a laser unit, comprising one or more laser sources; melting portions of the adjacent surfaces; and continuously pressing free surfaces, substantially parallel to the melted adjacent surfaces, using a press.

In some embodiments, providing the solid polymer material strand may include: continuously feeding, by a feeder, the solid polymer material strand; and continuously receiving and guiding the solid polymer material strand from the feeder using a guiding unit comprising a conduit. In some embodiments, providing the solid polymer material strand may include: placing the solid polymer material strand with respect to one of the substrate and the previously provided solid polymer material strand.

In some embodiments, the at least two strands are made from polyethylene or polypropylene. In some embodiments, the two or more solid polymer material strands comprises polymer material comprising laser absorbing additive. In some embodiments, the feeding is conducted at 0.1-1500 mm/sec. In some embodiments, melting portions of the adjacent surfaces is to a depth of 0.5-25% from a dimension of the strand perpendicular to the adjacent surface. In some embodiments, melting the adjacent surfaces is to a depth of 20-500 microns.

In some embodiments, pressing the solid strand and one of: the substrate and the previously provided continuous solid strand, one to another is by applying pressing force on at least one free surface of the solid strand.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A is a high-level schematic block diagram of an additive manufacturing system, according to some embodiments of the invention.

FIG. 1B is a high-level schematic illustration of a flow in the additive manufacturing system and their modification possibilities, according to some embodiments of the invention.

FIG. 1B′ is a high-level schematic block diagram of a laser based additive manufacturing system, according to some embodiments of the invention.

FIGS. 1C and 1D are high-level schematic illustrations of peripheral laser welding in the system, according to some embodiments of the invention.

FIG. 1E is a high-level schematic illustration of prior art laser welding.

FIG. 1F is a high-level flowchart illustrating a laser-based method of additive manufacturing, according to some embodiments of the invention.

FIG. 2 is a high level schematic illustration of the system, additively manufacturing a cylindrical part, according to some embodiments of the invention.

FIGS. 3A and 3B are high level schematic illustrations of tips and positioning unit of system, according to some embodiments of the invention.

FIGS. 4A and 4B are high level schematic illustrations of tips of the system, according to some embodiments of the invention.

FIG. 5 is a high-level schematic illustration of an exemplary strand production module and tip, according to some embodiments of the invention.

FIGS. 6A-6F are high level schematic illustrations of the system using strands as added material, according to some embodiments of the invention.

FIGS. 7A-7F are high level schematic configurations of attached strands at various spatial configurations, according to some embodiments of the invention.

FIGS. 8A-11 are high level schematic illustrations of various types of strands and their attachment, according to some embodiments of the invention.

FIG. 12 is a high-level flowchart illustrating a method of additive manufacturing, according to some embodiments of the invention.

FIG. 13A is a high-level schematic illustration of an additive manufacturing system including a printing head and a routing head, according to some embodiments of the invention.

FIG. 13B is a high-level schematic illustration of a printing head of an additive manufacturing system, according to some embodiments of the invention.

FIG. 13C is a high-level schematic illustration of a routing head of an additive manufacturing system, according to some embodiments of the invention.

FIG. 13D is a high-level schematic illustration of a hybrid head of an additive manufacturing system, according to some embodiments of the invention.

### DETAILED DESCRIPTION OF THE INVENTION

Prior to the detailed description being set forth, it may be helpful to set forth definitions of certain terms that will be used hereinafter.

The term “monolithic attachment” as used in this application refers to the connection of polymer parts at a level defined by given product requirement. The level of monolithic attachment may be selected according to the application. In certain embodiments, the level of monolithic attachment may be such that any two layers, strands and/or particles are separable only upon applying a certain percentage (e.g., 70%, 80%, 90% or 100%, depending on the case) of the force required to tear an equivalent uniform part. In certain embodiments, the monolithic attachment may include connecting the layers, strands and/or particles to each other in a uniform way that does not leave traces of the connection interface that are mechanically weaker than the surrounding material (roughly equivalent to 100% force mentioned above).

In the following description, various aspects of the present invention are described.

For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

The present invention relates to additive manufacturing by robotic 3D real production systems for direct manufacturing of real objects that are subsequently used as products. The manufacturing processes are streamlined to enable production of objects that meet required industrial standards to replace intensive labor and significant investments of production tooling. The present invention enables real production of objects that are generally hard to manufacture or expensive using conventional subtractive manufacturing methodologies. Clearly, the present invention also enables industrial production of small parts as well as production of prototypes and production of simple and cheap parts.

Systems and methods of additive manufacturing are provided, in which solid polymer material in form of strand(s) or particles is continuously received, and its surface is heated peripherally to liquefy the surface, using specified heating-related parameters which are selected to maintain a central volume of the continuously received solid polymer material in a solid state. The surface of a polymer substrate is also liquefied, and the peripherally heated surface of the continuously received solid polymer material is attached to the liquefied surface of the polymer substrate, followed by re-solidification of the liquefied surface to yield monolithic attachment of the material to the substrate. Liquefying only the surface of the material maintains some of its strength, as well as its flexibility and material properties, and prevents deformation and other changes upon solidification. The monolithic attachment provides uniform and controllable industrial products, which cannot currently be produced by polymer additive manufacturing.

Systems and methods of additive manufacturing are further provided, in which solid polymer material strands or layers are continuously received and have their surfaces heated peripherally by laser source(s) to liquefy/melt the surfaces. Specified heating-related parameters are selected to maintain a central volume of the continuously received solid polymer material strands or layers in a solid state. The strands or layers with liquefied surfaces are attached to each other to form a strip or a 3D object and possibly to a pre-produced substrate or a pre-produced strip and the surfaces are re-solidified to yield monolithic attachment of the material. Liquefying/melting only the surface of the material (e.g., 20-500 microns) maintains most of its original strength and prevents deformation upon solidification. The monolithic attachment provides industrial products with uniform and controllable characteristics. Laser welding utilizes laser radiation absorption by the polymer strands and enable continuous propagation of the strands to yield 3D printing of pre-defined structures.

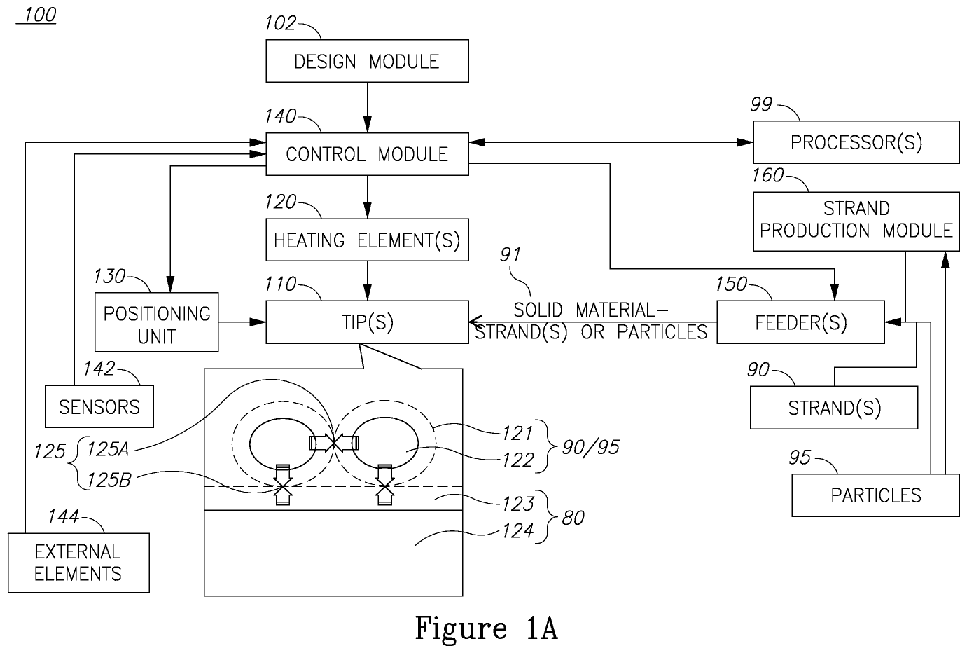

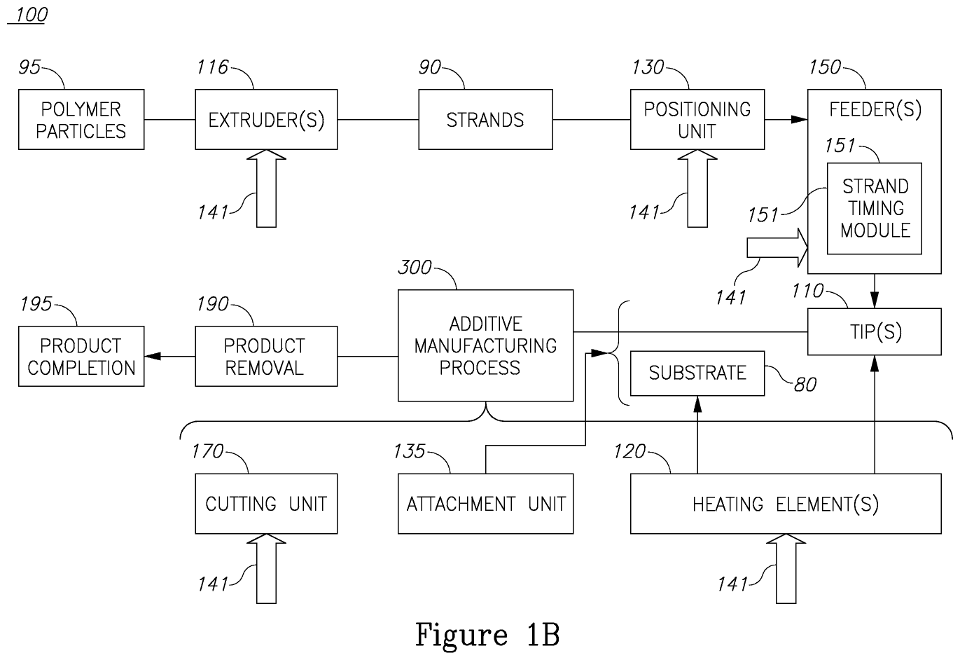

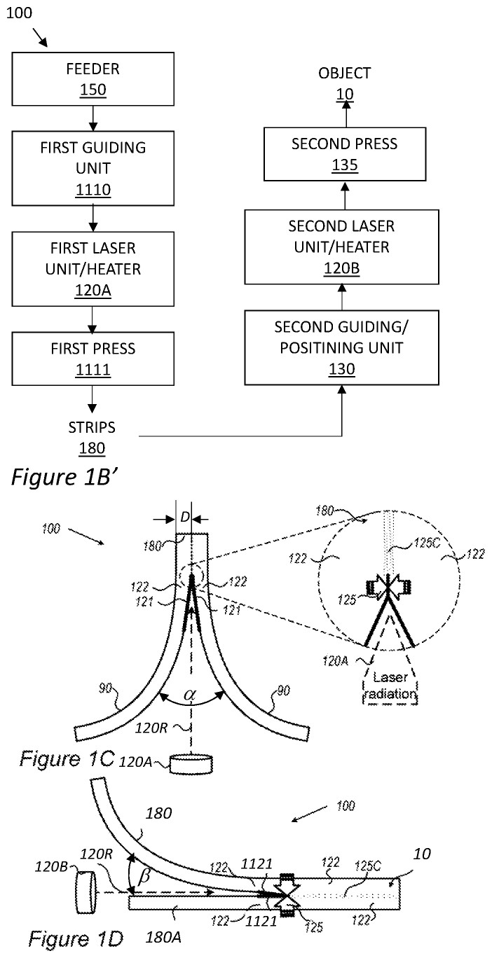

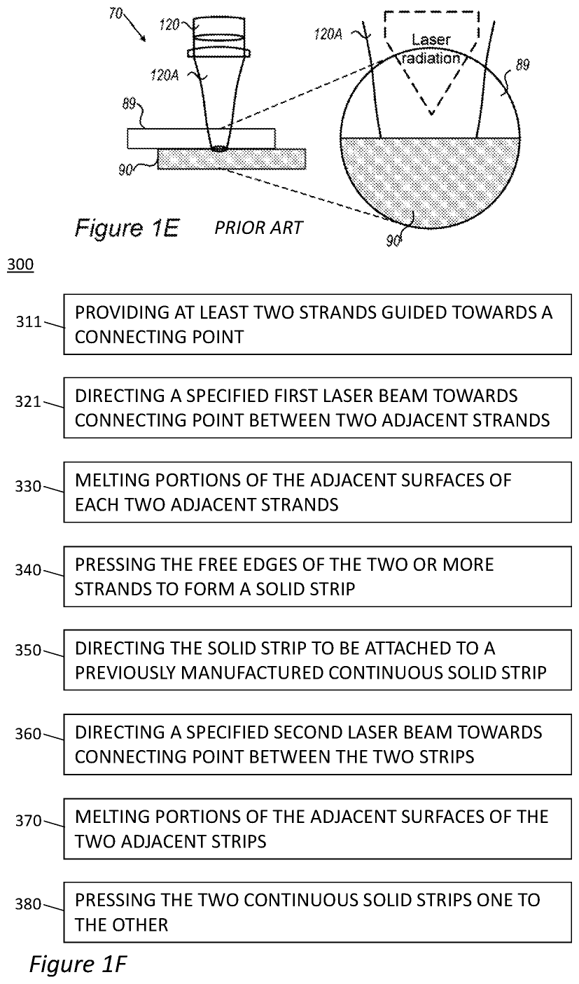

FIG. 1A is a high level schematic block diagram of an additive manufacturing system 100, according to some embodiments of the invention. Units in system 100 are illustrated schematically and may be implemented in various ways, some of which illustrated in the following figures. Units may be associated with processor(s) 99 for carrying out data processing related functions.

Additive manufacturing system 100 includes one or more feeder(s) 150 configured to feed, continuously, solid polymer material 91 in form of at least one strand 90 and one or more tip(s) 110 configured to receive, continuously, solid polymer strands 90 from feeder(s) 150. In the following, system 100 is sometimes described as having one tip 110 and one feeder 150 for simplicity, without limiting the scope of the disclosure thereto. Tip 110 may be understood as handling a single fed material strand or as handling multiple material strands, as described below.

System 100 further includes at least one heating element/laser unit 120 configured to heat strands 90 feed into tip 110 to a specified temperature. As used herein, heating unit 120 and laser unit 120 are alternatives and substitutes. At least one heating element 120 may be a laser which may further be configured to melt by laser heating at least part of a surface 123 of a polymer substrate 80, (for example, a strip 180 illustrated in FIG. 1D), leaving a bulk 124 of substrate 80 solid, and/or to liquefy by heating at least part of a surface 121 of fed strand 90 as the polymer substrate, leaving a core 122 of strand 90 solid. The actual depth of the part(s) of surfaces 121, 123 which are liquefied may vary depending on various parameters such as form and type of fed strand 90 and substrate 80 (respectively), heating-related parameters as presented below etc. The depth of the melted surfaces may be selected to maintain large enough material core 122 and substrate bulk 124 solid to provide required mechanical and shape properties of the produced part, while optimizing the solidification process and resulting part properties. For example, deeper liquefied surfaces require more intense heating yet provide more solidification time than shallower liquefied surfaces. The surface depths may be monitored and adjusted as part of the real-time process control described below. In some embodiments, the depth of the melted surfaces may be 0.5-25% from a dimension of each strand perpendicular to the melted surface 121 and 123. For example, the depth of the melted surfaces may be 20-500 micron.

In certain embodiments, up to 50% of the cross-sectional area of strand 90 may be liquefied, leaving at least 50% of the cross sectional area of strand 90 solid. Liquefied surface parts 121 may be circumferential or may extend only to one or more sides of the cross-sectional area of strand 90. For example, only one, two or three sides of a square cross section may be liquefied.

Tip 110 may include any element/unit that may be configured to guide and press strand(s) 90 fed from feeding unit 150, as disclosed and discussed in FIG. 1B′. Substrate surface 123 may be heated by heating elements/laser unit 120.

Moreover, disclosed systems 100 and methods 300 provide laser based additive manufacturing which is applicable to industrial processes and enable additive manufacturing of actual industrial parts, rather than merely of models as in the prior art. In particular, quality control is integrated in the manufacturing process, which provides uniform and closely monitored parts. Disclosed systems 100 and methods 300 are configured as robust additive manufacturing system and methods which enable handling received materials in the order of magnitude of several kilograms or several tens of kilograms per hour. Clearly, multiple systems 100 may handle larger amounts, and smaller system configurations may handle smaller amounts and finer details (e.g., ranging down to grams).

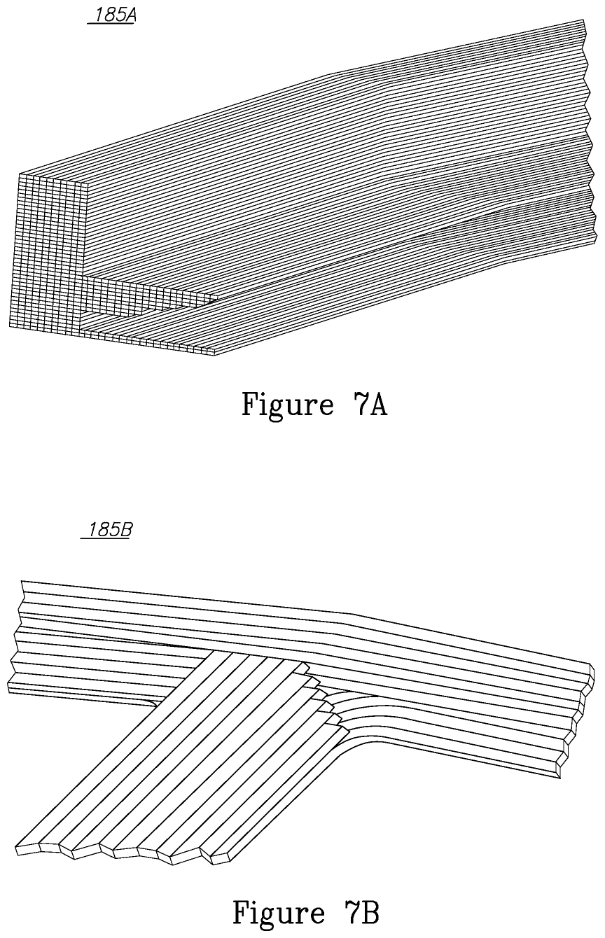

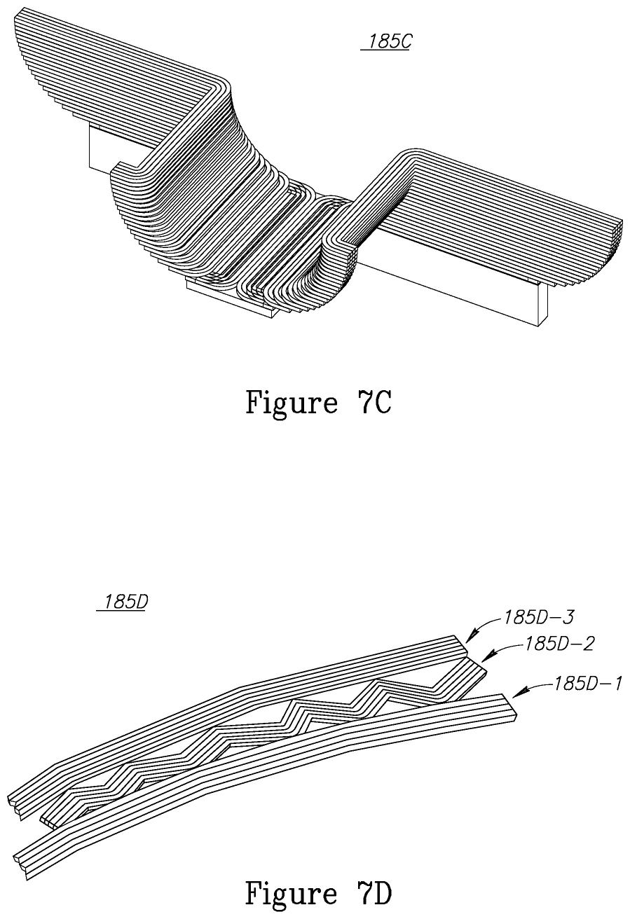

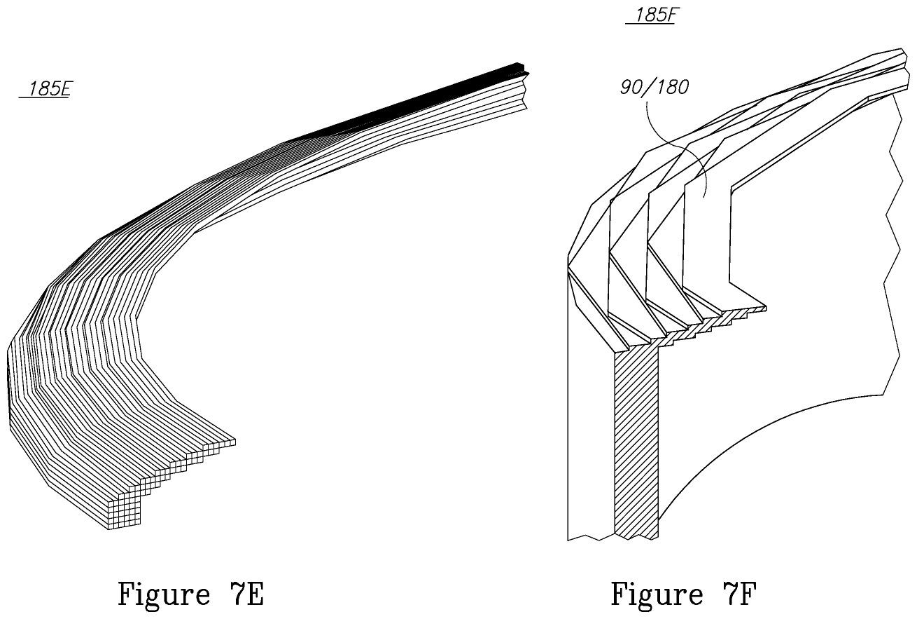

Liquefying only the periphery of received strand(s) 90 maintains the material strength during manufacturing, enabling production of overhanging structures (see e.g., FIGS. 7A, 7C, 7E, 7F below) without the need for additional supports and enables guiding or flexing received strand(s) 90 during production to achieve required shapes and surface/bulk features. The strength of the material core which is maintained solid enables production of overhanging structures without the need for additional supports, which is unheard of in the current state of the art. The monolithic attachment of received strand(s) 90 1 to substrate 80 maintains uniform mechanical characteristics throughout the manufactured parts.

The specified heating-related parameters may include, as examples, a selection of the laser heat source 120 in FIGS. 1C, 1D, etc. (e.g., LED laser, CO₂ laser, and the like), an applied wavelength (e.g., 700-3500 nm) a heating temperature, a heating duration as well as feeding parameters such as a feeding velocity (or a feeding force) of solid strand(s) 90, which determine the heating duration of fed strand(s) 90 and strips 180.

Additive manufacturing system 100 may further be configured to attach peripherally heated surface(s) 121 of continuously received solid polymer strand(s) 90 to liquefied surface(s) 123/121 of polymer strands 90, substrate 80 and/or strips 180, wherein the attachment to the substrate is achieved by a re-solidification 125A/125B (respectively) of the melted surface to yield monolithic attachment. As illustrated in FIG. 1A, any of the following options may be manufactured by system 100: two or more strands 90 may be attached to each other (one or more strand(s) being the respective substrate), one strand 90 may be attached to substrate 80 and/or two more strips 180 which may include a first strip that was previously produced by additive manufacturing system 100 and a second new strip, each of the strips includes a plurality attached strands 90. In any of these cases, the same operation principle is used, namely liquefying/melting only the surfaces of the attached elements to provide monolithic attachment without form change upon re-solidification. This operation principle enables production of parts having controlled and uniform characteristics.

Tip 110 may be further configured to receive and guide, continuously, one or more of solid material strands 90, which are attached to each other or to substrate 80 by re-solidification 125A of their liquefied surfaces 121 and/or 123, according to a spatial feeding configuration (e.g., a linear arrangement of strands 90 next to each other, or other configurations, see FIGS. 7A-7F for various non-limiting examples). Attachment may be assisted by tip 110 being further configured to press strands 90 against each other to enhance their attachment and/or by feeder 150 being further configured to feed strands 90 at specified angles with respect to each other that enhance their attachment. Accordingly, tip 110 may include a guiding unit 1110 (e.g., a first guiding unit) and a press 1111 (e.g., a first press), illustrated in FIG. 1B′.

Tip(s) 110 may have a wide range of designs, corresponding to fed strand 90, heating requirements and product design. For example, tip(s) 110 (e.g., guiding unit 1110) may include one or more openings/conducts, possibly with different shapes and sizes, and each process or process step may be used one, some or all of the openings. On or more opening in tip 110 (e.g., guiding unit 1110) may have an adjustable cross section. Tip(s) 110 may include additional elements such as co-dispensers of molten or semi-molten material and/or vibration units (internal or external, possibly using ultrasound). Tip(s) 110 (e.g., guiding unit 1110) may include guiding elements to guide material movement through tip(s) 110, wipers blending and smoothing strands 90 and/or attached strands 90 (e.g., by press 1111) as well as possibly pre-heating and post-cooling elements (e.g., laser heating element).

Feeder(s) 150 may be further configured to control feeding parameters of each strand 90 fed to tip 110. Feeding parameters may be used to control the form of the produced part, e.g., gradually increasing feeding speed in one direction of linearly fed strands may be configured to yield a bend of the produced part to the opposite direction—bending toward the slowly fed strands. For example, e.g., strands 90 which are fed at higher speed curve inwards, toward strands which are fed at lower speed.

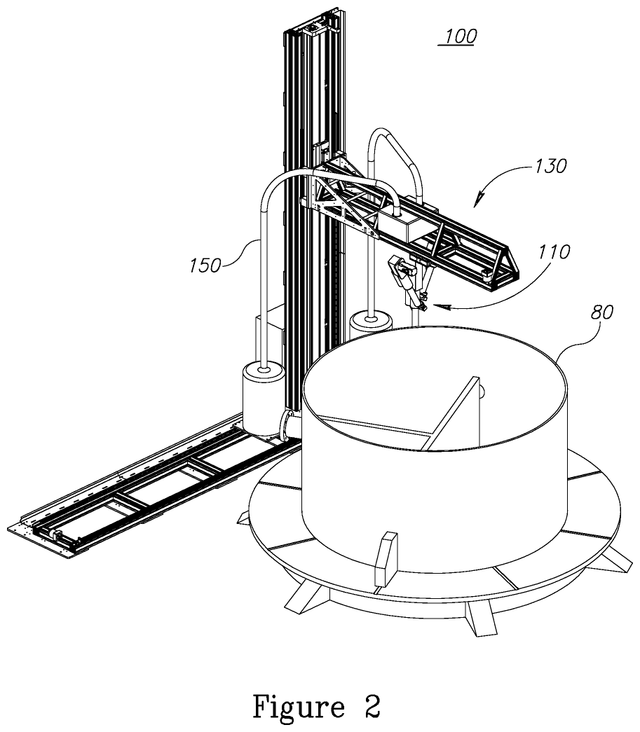

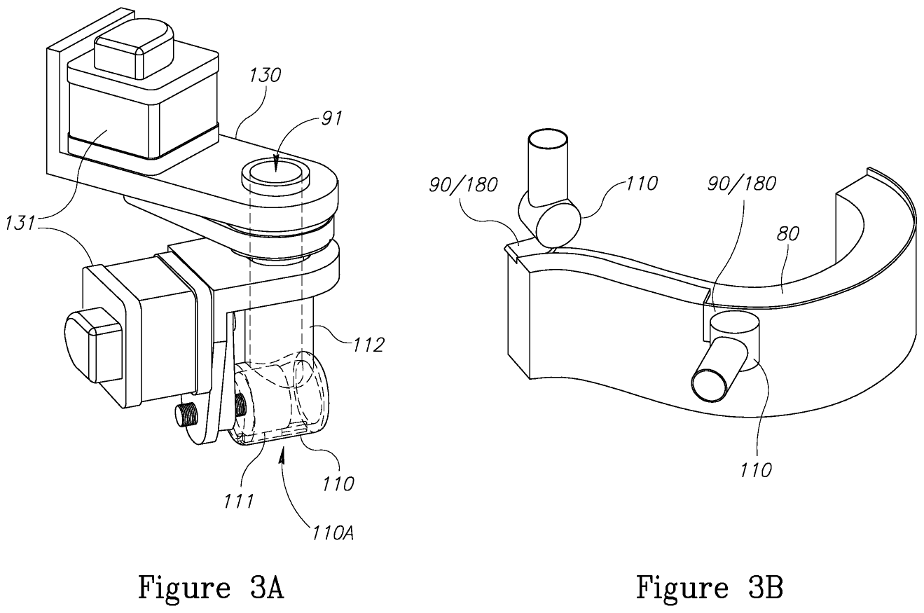

Strand(s) 90 may have any form of cross section (e.g., rectangular, round, triangular, hexagonal etc., see FIGS. 3B, 4B, 5, 7A, 8A, 9A, 10A, and 11 for non-limiting examples) and may be full or hollow (in case of hollow strands an inner periphery of the hollow in the strand is left solid during attachment). Strand cross section may be modified by the attaching process by the surface liquefaction and possible due to applied pressure. Attached strands 90 may differ, e.g., one or more of strands 90 may be made of different solid materials (e.g., different types of polymers), one or more strands 90 may be reinforced (e.g., by carbon fibers) and/or one or more of strands 90 may have additive(s) (e.g., fillers, colorants etc.). Using strands 90 of various types enables manufacturing complex parts, having specifically designed features. For example, system 100 may be used to manufacture parts such as containers having walls made of the strands (see FIG. 2 for a non-limiting example). The walls may have an external colored surface manufactured using external colored strands, intermediate light weight bulk manufactured using middle hollow, possible reinforced strands and inner passivated surface manufactured using inner strands with corresponding additives that suppress chemical reactivity. In some embodiments, strands 90 may be made from polyethylene or polypropylene. In some embodiments, strands 90 may include polymer material including laser absorbing additive. In some embodiments, the laser absorbing additives may include at least one of: carbon black powder, laser marking additives (e.g., including Sn or Sb particles) and the like.

System 100 may further include a strand production module 160 configured to produce strand(s) 90, continuously and simultaneously (on-line) with the feeding of strands 90 to tip 110. Strand(s) 90 may be produced from melting particles (e.g., by extrusion) just prior to their use in tip 110, after undergoing shape regulation in strand production module 160. For example, strand production module 160 may be configured to adjust a cross section of the produced strands according to specified attachment and structural requirements. Alternatively or complementarily, strands 90 may be fed by feeder 150 to tip 110 from rolls of strand produced off-line with respect to the operation of system 100. System 100 may further include another (e.g., a second) guiding/positioning unit 130 configured to guide strip 180, by position tip(s) 110 with respect to a previously manufactured strip 180 according to a specified product design. Second guiding/positioning unit 130 may follow detailed additive manufacturing process parameters to produce products or parts after specifications (which may be adapted to the unique manufacturing characteristics of system 100). Second guiding/positioning unit 130 may include one or more robotic units configured to position and maneuver tip(s) 110 according to the designed manufacturing process. Positioning unit 130 may include any of gantry(ies), bridge(s), robot(s), linear and rotary axes, rails, pulley(ies) etc. Second guiding/positioning unit 130 may be configured to operate multiple tip(s) 110, possibly manufacturing multiple parts, simultaneously.

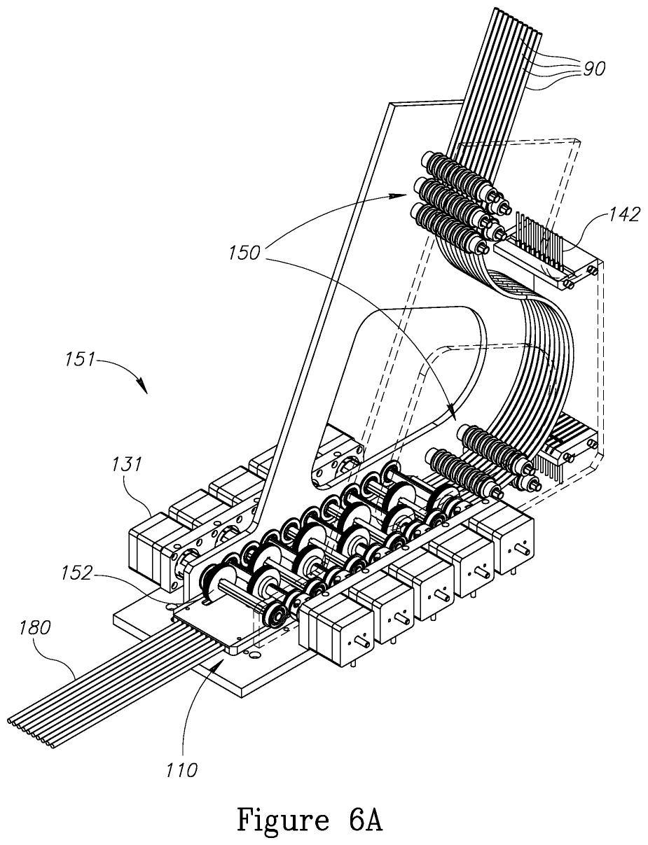

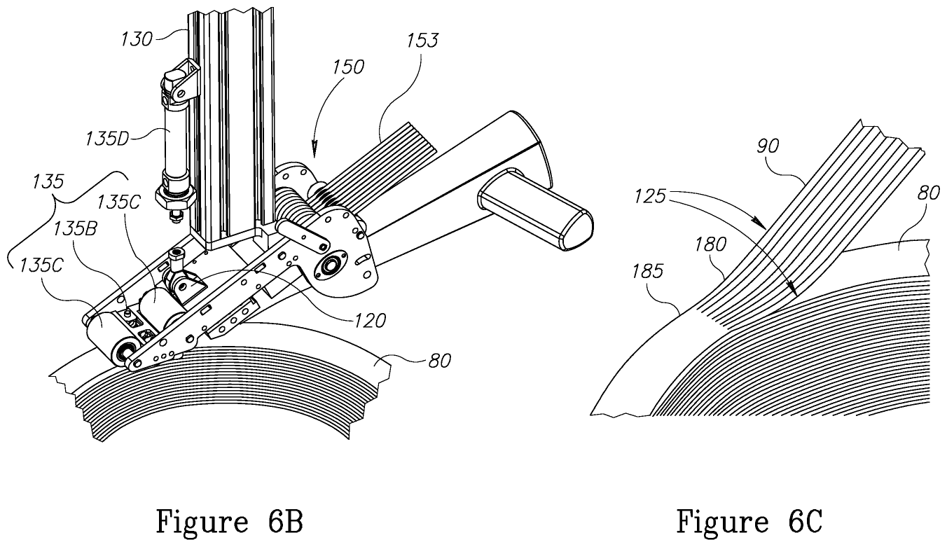

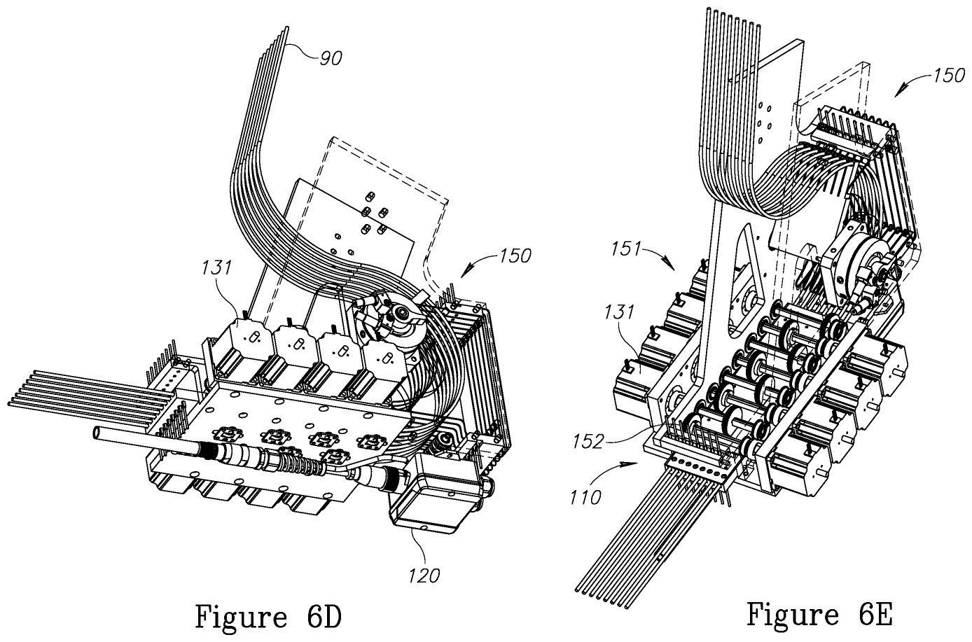

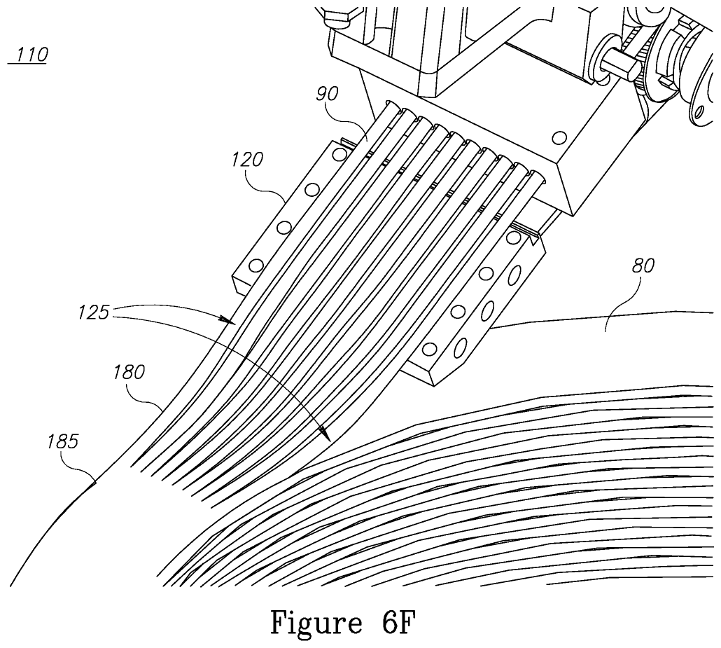

In some embodiments, system 100 may further include another (e.g., a second) press 135, illustrated in FIGS. 1B and 1B′, (that may also be included in tip 110). Second guiding/positioning unit 130 may be further configured to position tip 110 such that, second press 135 may press peripherally heated surface 121 of continuously received strip 180 against a previously manufactured strip 180 or substrate 80 as illustrated in FIG. 1D. Tip 110 may be configured to continuously receive and attach to each other multiple solid material strands 90, and position unit 130 may be configured to position tip 110 to simultaneously attach strands 90 to substrate 80 (see FIGS. 6A-6F for non-limiting examples).

System 100 further includes a control module 140 configured to control any of feeder(s) 150, heating element(s) 120, 120A and 120 B, guiding unit 1110, guiding/positioning unit 130, presses 1111 and 135 (illustrated in FIG. 1B′) and to monitor the attachment in closed loop to control a quality of the manufactured product. For example, the closed loop control may be implemented by control module 140 being configured to modify the feeding parameters and/or the specified heating parameters to determine a depth of surface liquefaction 121 with respect to a geometry of substrate 80, while maintaining central volume 122 in a solid state. Control module 140 may be configured to modify the specified heating and/or feeding parameters on-the-fly according to the monitored attachment and controlled quality. It is emphasized that control module 140 provides continuous control of the manufacturing process (not merely a layer-by-layer control as in other additive manufacturing processes) and continuously ensures the quality of the produced part.

Control module 140 may include multiple sensors 142 of various types (e.g., laser scanners, cameras, IR sensors, inductive and capacitance sensors, acoustic sensors, temperature sensors) configured to monitor the production process, e.g., measure positions of system elements, measure temperatures such as actual material and nozzle temperature profile and compare to planned and or past data, surface temperatures, measure material properties (e.g., volume, material mixtures and properties of material components) and their variation. Control module 140 is further configured to correct any of the measured features by modifying heating and feeding parameters, positioning unit movements etc. For example, correction criteria may be set, such as volumetric and dimensional constraints and tolerances for part parameters such as size, surface features, flatness and perpendicularity, critical features (e.g., a hole, a flange, connectors etc.), material strength, standards, textures etc. Process corrections by control module 140 may be carried out on the fly (real time) and/or at spatio-temporal intervals or after production. Corrections may be implemented by using the measured variation to (i) adjust the planned dimension to actual manufactured features (adaptive manufacturing, e.g., changing manufacturing parameters according to certain shifts in the substrate), (ii) create gradual corrections to gradually restore the dimensions to the original design, (iii) suggest or prompt design modification, (iv) add supports that correspond to monitored variation and/or (v) change material flow characteristic (e.g., size of orifice in tip 110, temperature, geometry of molten mass, process speed, etc.). Additionally or alternatively, control module 140 may be configured to use other devices or external elements 144 for carrying out the corrections such as second end-effectors or elements—for example, heat/cooling sources, wipers, hammer-like units, spindles and/or final machining or other external robots or machines.

Solid polymer strand(s) 90 and/or strips 180 may include polypropylene (PP) or polyethylene (PE) which have large thermal expansion coefficients (in the order of magnitude of 10-4 m/(m K) and higher). System 100 and method 300 disclosed below enable additive manufacturing at industrial scale using PP or PE which is not possible with prior art technology, as the latter liquefies all the material, which then undergoes shape and dimensional changes upon re-solidification that contort the manufactured product and result in uneven mechanical properties of the product. In contrast, the disclosed systems and methods maintain the form and the mechanical properties of solid central volume 122 of the polymer material and provide uniform re-solidification and uniform mechanical attachment of strand(s) 90 and/or strips 180 to substrate 80 resulting in shape and mechanical properties of the manufactured products which can be designed to yield industrially viable parts. Moreover, the closed loop process controls and provides on-line verification of the quality of manufacturing, ensuring uniform part batches according to design and having uniform mechanical properties. Clearly, polymer materials with smaller thermal expansion coefficients (e.g., in the order of magnitude of 10-5 m/(m K) and lower, e.g., ABS-acrylonitrile butadiene styrene, PC-polycarbonate etc.) may also be used.

System 100 may further include a design module 102 configured to produce a proper process design of given parts using system 100. For example, strands 90 may be optimized for certain requirements, added layers may be design according to product requirements, positioning unit movements may be minimized, material cuttings reduced, and special features may be adapted for the additive manufacturing (e.g., sharp corners). Design module 102 may receive modifications from control module 140 during and after manufacturing to improve the process design and the manufacturing process.

FIG. 1B is a high-level schematic illustration of a flow in additive manufacturing system 100 and their modification possibilities, according to some embodiments of the invention. FIG. 1B illustrates schematically the flow, starting from raw material such as polymer particles 95 which may include PP or any other thermoplastic polymer possibly with various additives (e.g., UV protective materials, fillers) and various reinforcement components (e.g., carbon fibers, glass fibers etc.), which is drawn to strand(s) 90 by an extruder 161 as a non-limiting example, either on-line or off-line with respect to the operation of system 100. Strands 90 may have any cross section (round, square, triangular), any dimension or form, and may be co-extruded from more than one extruder and include multiple materials. Extruder(s) 161 may be controlled 141 by control unit 140 to provide strands that correspond to product requirements and to provide online closed loop manufacturing control and quality assurance (QA).

Positioning unit 130 may include any system such as robotic units, arms, gantries, bridges or even remotely controlled rotorcraft(s), and may also be controlled 141 by control unit 140 to control the positions and movements of components of system 100 (at all directions) and particularly of tip(s) 110 according to product requirements and to provide online closed loop QA.

Feeder(s) 150 may include a strand timing module 151 which feeds strand(s) 90 to tip 110, possibly at different speeds relating to the geometric configurations of part production, heating parameters, strand materials and possibly synchronized with extruder(s) 161. Feeder(s) 150 and/or strand timing module 151 may be controlled 141 by control unit 140 to control the feeding parameters of each strand (together or separately) according to product requirements and to provide online closed loop QA. Strand timing module 151 enables exact control on strand feeding speed and provides full control on the geometry of the manufactured product, e.g., by providing feeding speeds that correspond to specific product radii and surface features, by providing corresponding strands to specific product parts and modifying the composition of strands during manufacturing and so forth.

Tip(s) 110 may include any multi-channel unit for handling multiple strands and for heating and attaching the strands to provide manufactured stripes (see FIGS. 3B, 6A-6F, 7A, 7D-11) to be added to substrate 80, previously provided strand 90, or previously manufactured strip 180. Tip(s) 110 may have various cross sections, constant or variable, and may enable control of the feeding angles of the strands. Laser units (e.g., heating element(s)) 120 may include one or more laser sources, each source is directed to deliver a specified laser beam (e.g., tangentially) with respect to adjacent surfaces of two adjacent strands 90 towards a connecting point. The heating levels as part of the heating parameters may be adjusted according to product specifications, geometry and strand materials, and may be controlled 141 by control unit 140 to according to product requirements and to provide online closed loop quality assurance (QA).

System 100 may include an attachment unit/second press 135 configured to attach a new strip 180 with liquefied/melted surface to substrate 80 or to previously manufactured stripe 180 (see e.g., FIGS. 3B and 6F) controllably, e.g., using one or more rollers/press. System 100 may further include a cutting unit 170 configured to cut edges of stripes 180 and/or strand 90 to provide finish requirements of the produced parts (e.g., using a laser cutter). Once additive manufacturing method 300 is finished, the manufactured product is removed from the manufacturing region 190 (or system 100 moves to a different production region) and the product is completed 195 (e.g., is added components, finished, assembled, etc.) and tested.

Reference is now made to FIGS. 1B′ and 1C. FIGS. 1B′ is a high-level schematic block diagram of a laser based additive manufacturing system 100, according to some embodiments of the invention and FIG. 1C is an illustration of peripheral laser welding in system 100, according to some embodiments of the invention. System 100 may include feeder 150 configured to continuously feed, one or more solid polymer material strands 90, as disclosed herein. In some embodiments, feeder 150 is configured to feed two or more strands 90.

System 100 may further include a first guiding unit 1110 including one or more (e.g., two or more) conduits to continuously receive and guide one or more (e.g., two or more) solid polymer material strands 90 from feeder 90 towards a connecting point 125 (illustrated in FIG. 1C). System 100 may further include a laser unit 120A (e.g., a first laser unit), including one or more laser sources, such that, each source is directed to deliver a specified laser beam (e.g., tangentially) with respect to adjacent surfaces 121 of two adjacent strands 90 towards connecting point 125. In some embodiments, two or more specified laser beams from two or more laser sources may be directed towards a single connecting point 125.

In some embodiments, system 100 may further include press 1111 configured to press free surfaces of the two or more strands 90 to form a continuous solid strip 180. In some embodiments, press 1111 may be configured to press strand 90 to substrate 80 or to a previously provided strand 90. In some embodiments, system 100 may further include a second guiding unit 130 configured to continuously direct continuous solid strip 180 to be attached to a previously manufactured continuous solid strip 180A or to substrate 80, as illustrated in FIGS. 1A and 1D. System 100 may further include a second laser unit 120B, including one or more laser sources, each source is directed to deliver a specified laser beam (e.g., tangentially) with respect to adjacent surfaces 1121 of the continuous solid strip 180 and previously manufactured continuous solid strip 180A or substrate 80. System 100 may further include a second press 135 configured to press the two solid strips 180 and 180A one to the other and/or solid strip 180 to substrate 80, for form a 3D product 10.

In some embodiments, first press 1111 may be configured to apply 0.1-10 bar, to press the free surfaces of two or more strands 90 or at least one free surface of strand 90 to substrate 80, for example, using two rollers. In some embodiments, first press 1111 may be configured to apply a force of 0.5-500 N. In some embodiments, second press 135 may be configured to apply 0.1-10 bar, for example, by a roller pressing strip 180 down towards strip 180A. In some embodiments, second press 135 may be configured to apply a force of 0.5-500 N.

In some embodiments, the heating parameters may be optimized in order to control the depth of the melted surfaces. For example, each one of one or more laser sources (of laser unit 120A and/or laser unit 120B) applies laser beam at an intensity optimized to melt 20-500 microns of the surface of solid polymer strand 90. In some embodiments, the one or more laser sources may be optimized to melt adjacent surfaces 121, 123 or 1121 of the solid polymer strands 90, substrate 80 or strip 180/180A to a depth of 0.5-25% from a dimension D of each strand perpendicular to adjacent surfaces 121, 123 and/or 1121.

Additional parameter that may control the depth of melted surfaces 121, 123 and/or 1121 may be the feeding velocity. Accordingly, feeder 150 may be configured to continuously feed one or more solid polymer material strands 90 at a feeding velocity optimized to allow the laser beams to melt 20-500 microns of surface 121 of solid polymer strands 90, melt 20-500 microns of surface 123 of substrate 80 and/or to melt 20-500 microns of surface 1121 of strip 180/180A. In some embodiments, feeder 150 may be configured to continuously feed one or more solid polymer material strands 90 at a feeding velocity optimized to allow the laser beams to melt adjacent surfaces 121 or 123 to a depth of 0.5-20% from dimension D of each strand perpendicular to adjacent surface 121.

In some embodiments, at least one laser source 120 may be positioned to apply specified laser radiation 120R (e.g., tangentially) with respect to the surface parts of strand(s) 90 and/or substrate 80. The illumination of strand(s) 90 may be configured to melt only peripheral part/surface 121 or surface 123 thereof. As disclosed herein, system 100 may be further configured to attach strands 90 at their peripherally heated/melted surface parts 121 at connection point 125, (e.g., by first press 1111) to yield monolithic attachment (illustrated schematically as part 180 with re-solidified zone 125C). Alternatively, system 100 may be further configured to attach strand 90 to substrate 80 at their peripherally heated/melted surface 121 and 123. System 100 may be further configured to continuously deliver strand(s) 90 during the laser welding according to geometrical parameters of a pre-defined structure.

In some embodiments, the two or more conduits of first guiding unit 1110 may be located such that two or more strands 90 are directed one toward the other at a predetermined angle α, for example, of 2-80 deg. In some embodiments, feeder 150 may be configured to the direct solid strand 90 toward one of: substrate 80 and previously provided solid strand 90 at a predetermined angle of 2-80 deg in some embodiments, second guiding unit 130 may be configured to direct strip 180 towards strip 180A at a predetermined angle β, for example, of 2-80 deg.

Advantageously, with respect to prior art 70 illustrated schematically in FIG. 1E, disclosed systems 100 enable 3D printing using laser welding of polymer strands which are controllable moved and positioned to form pre-defined 3D objects. Prior art laser welding 70 has one (89) of the welded elements being transparent to laser radiation 120R, and includes passing the laser radiation through part 89 to the welding location to another part 90. In contrast, disclosed embodiments 3D-print opaque polymer strands 90, which are not transparent and absorb laser radiation 120R to heat up and be liquified. The application of laser radiation 120R to liquify only surface parts of strands 90 enables: (i) use of laser absorbing polymers and laser and wavelengths that are absorbed by the polymer material, (ii) attaching strands 90 to each other to form monolithic attachment with no or minimal distortions and high attachment strengths; and (iii) movement of strands 90 to generate continuous liquefication of their surfaces and yield the continuous 3D printing process. Accordingly, disclosed systems and method enable 3D polymer printing using laser welding, which is not available in the prior art.

In certain embodiments, laser radiation 120R may be used within a wide range of wavelengths, depending on the available technology, materials used and performance and cost considerations. For example, laser radiation 120R may be used within one or more bands included in the range of 700-2500 nm (near infrared, NIR), and/or possibly at longer wavelengths of several microns (short wave infrared, SWIR and middle wave infrared, MWIR). In the NIR, commonly used materials such as polypropylene and polyethylene are quite transparent and in certain embodiments, absorptive materials such as carbon black and/or laser marking additives (e.g., including Sn or Sb particles) may be added to the strand material to increase laser absorption and heating. In the MWIR, commonly used materials such as polypropylene and polyethylene are absorptive to the radiation and may be used without absorption additives. Selection of laser source(s) 120 and additives may be carried out with respect to the available technology, materials used and performance and cost considerations.

Referring back to FIGS. 1B′, 1C and 1D, the one or more laser sources of either laser unit 120A or laser unit 120B, apply laser beams having 700-1300 nm wavelength. In some embodiments, applying laser at a wavelength below 700 nm may not result in any melting of surfaces 121, 123 and 1121. A would have being known in the art, the preferable wavelength for melting PP and/or PE is approximately 2500 nm. However, the inventors surprisingly found that for the purpose of melting the surface of a strand or a strip laser units 120A and/or 120B may apply laser beams having 900-1100 nm wavelength.

In various embodiments, system 100 may for example further include any of the following configurations and elements, disclosed herein: tip 110 may include press 1111, therefore, may be further configured to press strands 90 against each other to enhance their attachment; the spatial feeding configuration may be a linear arrangement of strands 90 next to each other; the specified heating-related parameters may include any of: at least one laser source 120, laser intensity (e.g., power [watt]) a heating temperature, a heating duration and a feeding velocity of the strands; and system 100 may be further configured to modify the specified heating-related parameters to determine a depth of surface liquefaction with respect to a predefined structure geometry, while maintaining the central volume of the strands in a solid state, as discussed herein above.

In various embodiments, strands 90 may include at least one hollow strand, strands of different solid materials, at least one reinforced strand and/or at least one strand with an additive, for example, laser absorbing additive. In various embodiments, the solid polymer material includes polypropylene or polyethylene, or any other polymer that absorbs laser radiation 120A and is appropriate for 3D printing.

In various embodiments, system 100 may for example further include any of: strand production module 160 configured to produce strands 90, continuously and simultaneously with the feeding; second guiding unit 130 configured to position strip 180 with respect to substrate 80 or strip 180A according to a specified product design and optionally a routing head (see below) that is coupled to second guiding 130 and configured to perform on-line processing of the attached polymer material and attachment thereof to the substrate; and/or control module 140 configured to control feeder(s) 150, laser source(s) 120A and 120B and/or second guiding unit 130, to monitor the attachment in closed loop to control a quality of a manufactured product 10.

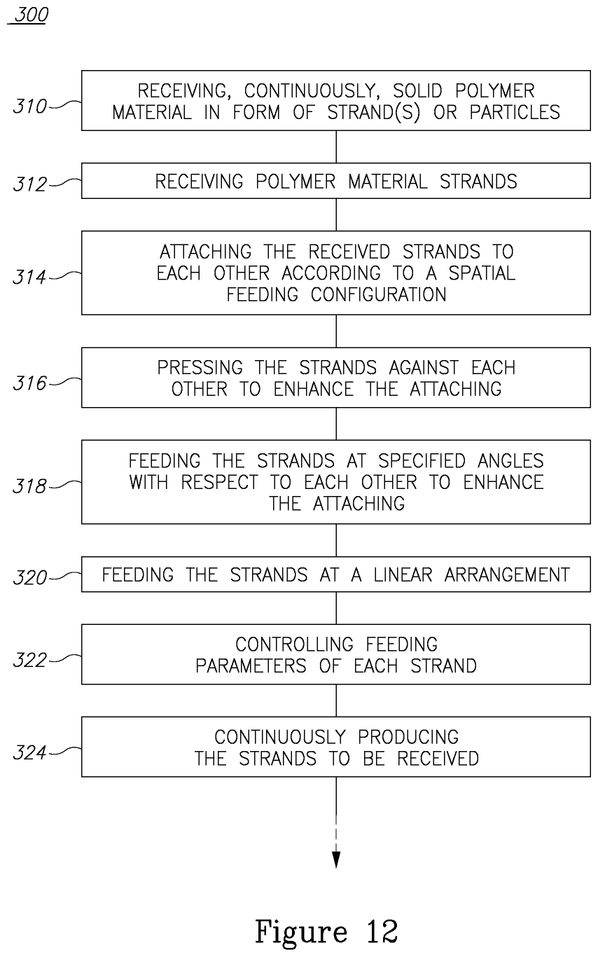

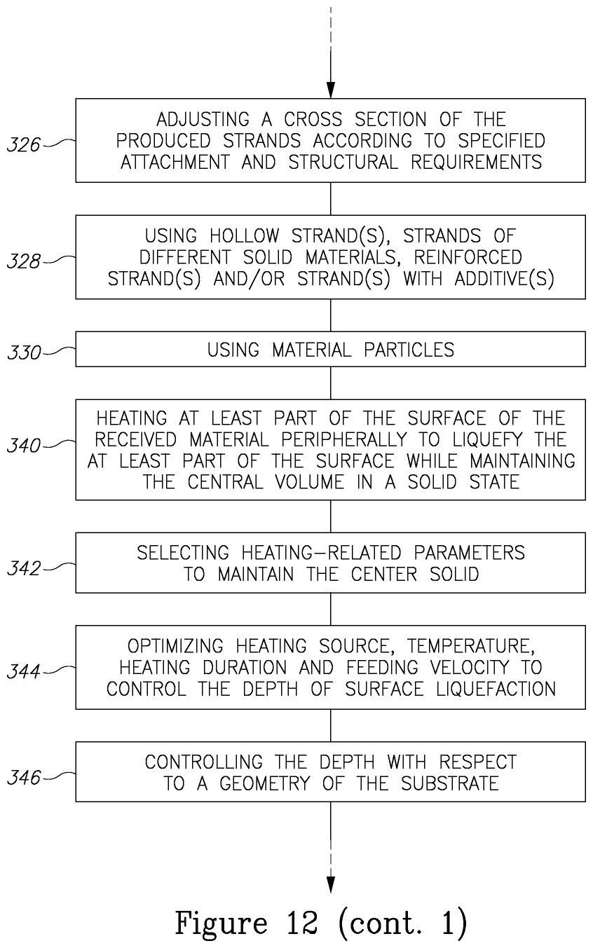

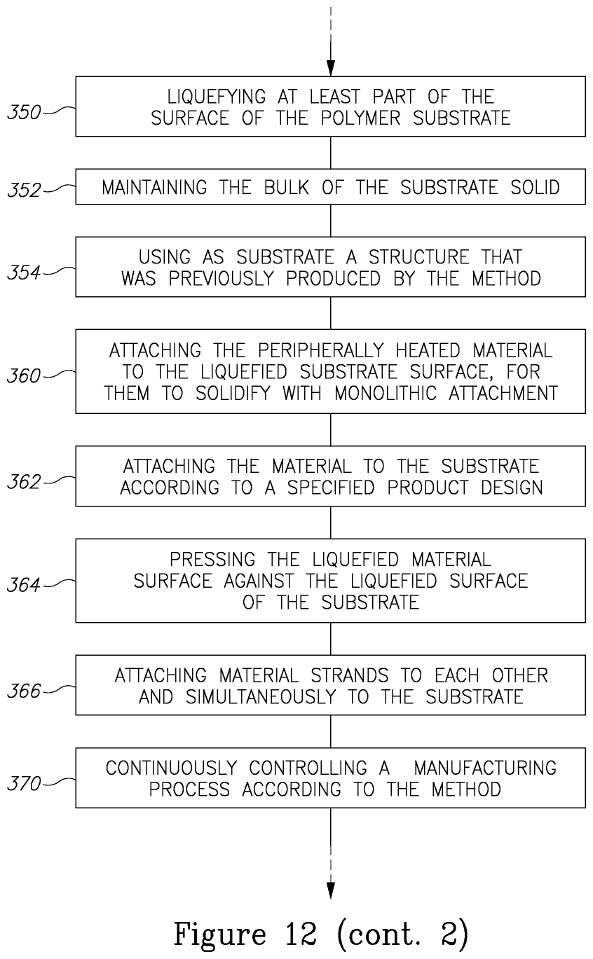

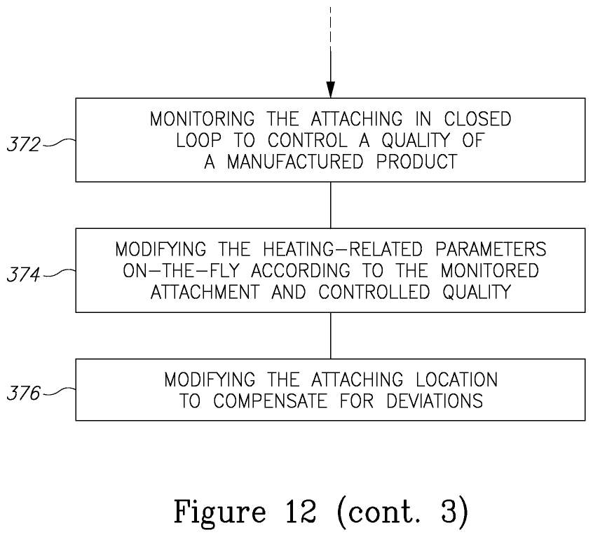

FIG. 1F is a high-level flowchart illustrating a method 300 of a laser based additive manufacturing, according to some embodiments of the invention. The method stages may be carried out with respect to system 100 described above, which may optionally be configured to implement method 300. Method 300 may be partially implemented, with respect to the control processes, by at least one computer processor. Certain embodiments include computer program products including a computer readable storage medium having computer readable program embodied therewith and configured to carry out of the relevant stages of method 300. Stages presented in FIG. 1F may be combined with stages presented in FIG. 12 below, which further illustrates method 300. Method 300 may include any of the following stages, irrespective of their order.

Method 300 of laser based additive manufacturing may include, in step 311, continuously providing one or more solid polymer strands. In some embodiments, two or more strands may be guided towards a connecting point of adjacent surfaces of each two strands. In some embodiments, one solid polymer strand may be guided towards a connecting point with one of: a substrate and a previously provided solid polymer material strand. In some embodiments, the provision of least two solid polymer strands 90 towards a connecting point 125, may include continuously feeding, by feeder 150, two or more solid polymer material strands 90 and continuously receiving and guiding the two or more solid polymer material strands 90 from feeder 150 using a first guiding unit 1110 including two or more conduits. In some embodiments, providing at least two adjacent strands may include placing a first solid polymer material strand with respect to a second solid polymer material strand. In some embodiments, feeder 150 may feed strand(s) 90 at 0.1-1500 mm/sec.

In some embodiments, the provided strand(s) 90 may be made from PP or PE. In some embodiments, the polymer material of strands 90 may include additives that allows absorb inf a specified laser radiation. In some embodiments, a first strand from the at least two strands 90 maybe made from a first type of polymer (e.g., PP) and a second strand from the at least two strands 90 may be made from a second type of polymer (e.g., PE). For example, the first strand may include PP and the second modified PP (e.g., PP with fillers).

In step 321, a specified laser beam (e.g., laser radiation 120R) may be continuously directed and delivered towards each connecting point, using a first laser unit 120A, including one or more laser sources. In some embodiments, at least one laser unit 120A may be positioned to illuminate the strands. In some embodiments, the strands may be guided during the laser welding according to geometrical parameters of a pre-defined structure.

In step 330, portions of the adjacent surfaces 121 of each two adjacent strands 90 may be melted during the application of radiation 120R. Alternatively, adjacent surfaces 121 and 123 of stand 90 and substrate 80 may be melted. In some embodiments, the melted portions of adjacent surfaces 121 and or 123 of strands 90 or substrate 80 may have a depth of 0.5-25% from a dimension D of each strand 90 perpendicular to adjacent surface 121. In a nonlimiting example, the melted portions of adjacent surfaces 121 and/or 123 have a depth of 20-500 microns.

In step 340, the free surface, substantially parallel to melted adjacent surfaces 121, of two or more strands 90, may be pressed to bond the melted adjacent surfaces 121 to form solid strip 180, using a first press 1112. In some embodiments, pressing the free surfaces of two or more strands 90 to form solid strip 180, using first press 1112 is conducted from two sides of solid strip 180. Alternatively, step 340 may include continuously pressing free surfaces, substantially parallel to the melted adjacent surfaces 121 and 123, using a press 1112.

In some embodiments, method 300 may further include forming 3D object 10 from solid strips 180.

In step 350, continuous solid strip 180 may be directed to be attached to previously manufactured continuous solid strip 180A or substrate 80, using a second guiding unit 130.

In step 360, a second specified laser beam 120R, may be directed with respect to adjacent surfaces 1121 of the continuous solid strip 180 and the previously manufactured continuous solid strip 180A or surface 123 of substrate 80, using a second laser unit 120B, including one or more laser sources.

In step 370, portions of adjacent surfaces 1121 and/or 123 of strip 180 and one of: substrate 80 and previously manufactured continuous solid strip 180A be melted by the application laser beam 120R.

In step 380, continuous solid strip 180 and one of: substrate 80 and previously manufactured continuous solid strip 180A, may be pressed one to the other, using a second press 135, to form 3D object 10. In some embodiments, pressing two strip 180 and 180A one to another is by applying pressing force on a free face of strip 180.

In various embodiments, method 300 may for example further include any of the following stages, listed in FIG. 12 below: attaching the strands to a structure that was previously produced by the method; pressing the strands against each other to enhance the attaching, by feeding the strands at specified angles with respect to each other; and monitoring attaching 360A in closed loop to control a quality of a manufactured product.

In various embodiments, the strands may include at least one of: at least one hollow strand, strands of different solid materials, strand(s) of recycled material(s), at least one reinforced strand and at least one strand with an additive; the specified heating-related parameters may include at least one of a heat source, a heating temperature, a heating duration and a feeding velocity of the solid material; and the method further includes modifying the specified heating-related parameters to determine a depth of surface liquefaction with respect to a predefined structure geometry, while maintaining the central volume of the strands in a solid state; and the solid polymer material may include polypropylene, polyethylene or other polymer materials which absorb the laser radiation.

FIG. 2 is a high-level schematic illustration of system 100 additively manufacturing a cylindrical part, according to some embodiments of the invention. FIG. 2 schematically illustrates substrate 80 as an additively manufactured cylindrical part such as container, possibly positioned on a turntable (associated with positioning unit 130 and controlled by control unit 140) and being produced by additive manufacturing via tip 110 receiving material from feeder 150 and positioned by positioning unit 300. Control unit 140 is not shown, yet may include remote user interface (e.g., via a cloud service, communication link, etc.), a design module and corresponding monitoring and control software. The cylindrical part may be manufactured simultaneously by multiple tip(s) 110.

FIGS. 3A and 3B are high level schematic illustrations of tips 110 and positioning unit 130 of system 100, according to some embodiments of the invention. In the illustrated non-limiting design, positioning unit 130 may include motor(s) 131 configured to position tip 110 correctly, a cavity 112 through which material 91 is fed and a plunger as an aperture control member 111 configured to modify the size and possibly form of an aperture 110A in tip 110. Plunger 111 is possibly controlled by one of motor(s) 131. Heating the surface of material 91 may be carried out via aperture control member 111 (such as the plunger) and/or via cavity 112. One or more tip 110 may be used to deposit material on substrate 80 in any direction, e.g., on horizontal or vertical surfaces of substrate 80. The deposited material may include attached broad strands 90 and/or stripes 180 composed from thin strands 90 attached to each other in tip 110.

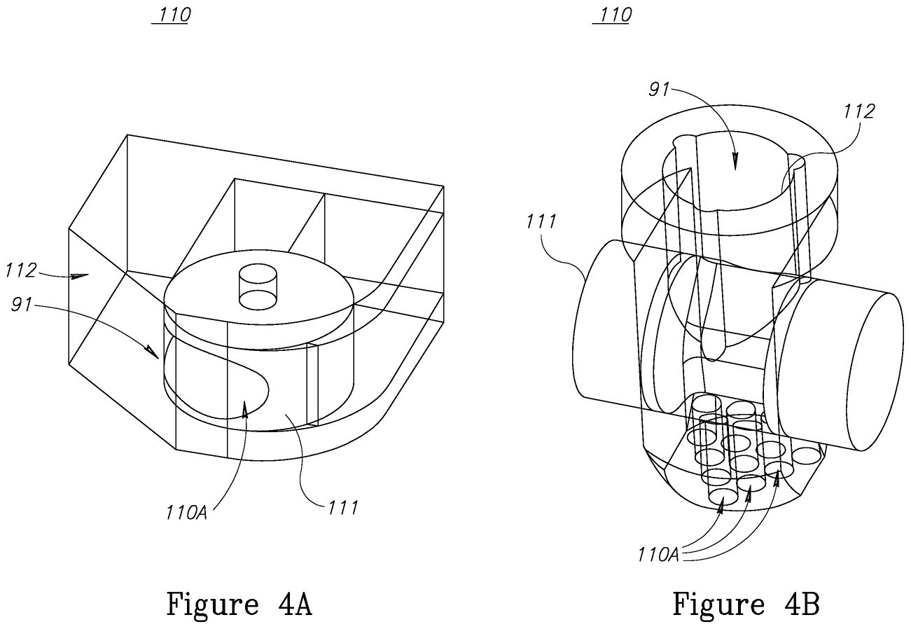

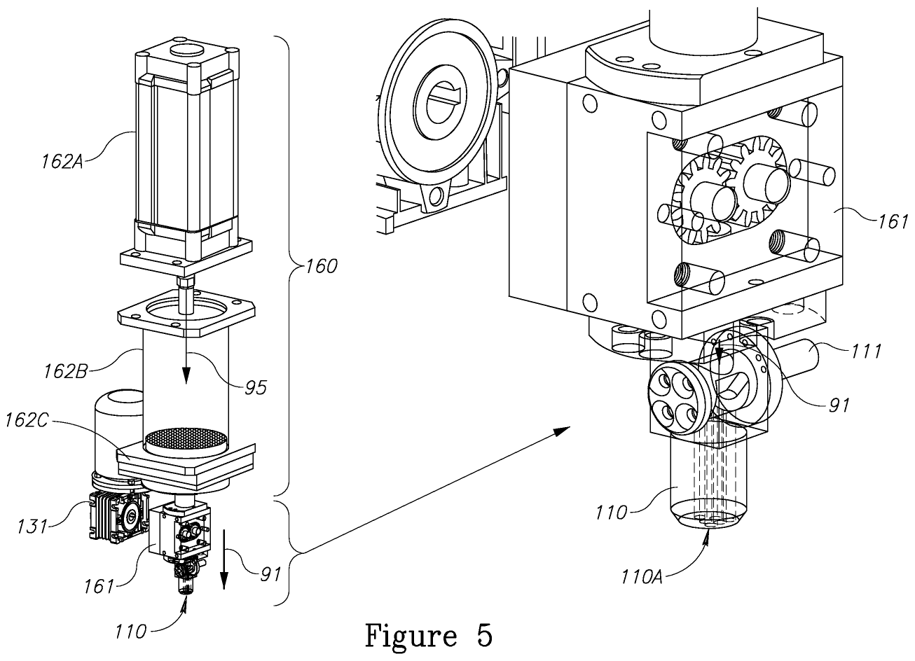

FIGS. 4A and 4B are high level schematic illustrations of tips 110 of system 100, according to some embodiments of the invention. In FIG. 4A, aperture control member 111 is illustrated as a rotary unit with a channel of variable opening. Upon rotation of rotary unit 111, the size and form of aperture 110A in tip 110 changes to modify the extruded material. In FIG. 4B, aperture control member 111 is illustrated as a rotatable rod having a varying profile that controls a number of available apertures 110A in tip 110, which may receive strands 90. Heating the surface of material 91 may be carried out via aperture control member 111 (such as the rotary unit or rotatable rod) and/or via cavity 112.

FIG. 5 is a high-level schematic illustration of exemplary strand production module 160 and tip 110, according to some embodiments of the invention. In the illustrated non-limiting embodiments, strand production module 160 may include a piston 162A pushing raw material 95 such as pellets into a raw material container 162B. The raw material is then melted by heater 162C and extruded by extruder 161 (e.g., a dosage pump driven by motor 131 through multiple holes) to provide solid strands 90 to tip 110, in which the surfaces of strands 90 may be liquefied prior to their attachment. Aperture control member 111 may be configured similarly to the illustration in FIG. 4B to control the number of strands 95 provided to tip 110 and exiting aperture(s) 110A.

FIGS. 6A-6F are high level schematic illustrations of system 100 using strands 90 as added material 91, according to some embodiments of the invention. FIG. 6A schematically illustrates feeder 150 receiving strands 90 and directing them to tip 110 and includes strand timing module 151 having a plurality of motors 131 and wheels 152 driven by respective motors 131 and configured to move and control strands 90 fed to tip 110 (e.g., with respect to required manufacturing geometry). Sensors 142 may be configured to provide feedback on strand status (e.g., strand presence and type, velocity etc.). The separate control of each strand 90 provides precise control on the manufacturing process. FIG. 6B schematically illustrates attachment unit 135 including a guiding roller 135C, side rollers 135B and an attachment roller 135C configured, respectively, to guide strands 90 towards tip 110, secure the lateral positions of strands 90 and possibly press strands 90 against each other, and ensure adhesion and contact between strands 90 and/or attached strands 180 and substrate 80. Positioning unit 130 may further include a piston 135D for pressing tip 110 against substrate. Attachment of strands 90 to substrate 80 may include a relative movement therebetween to enhance the uniformity of the re-solidification. Heating element 120 may be positioned adjacent to attachment unit 135 to liquefy strand surfaces. Feeder 150 may include guides 153 configured to feed strands 90 at specified angles into tip 110, either parallel or at specified angles which may be selected to provide additional lateral pressure among strands 90 that may be selected to further enhance their attachment. Guides 153 may be configured to provide a selected spatial configuration of strands 90, as exemplified below. FIG. 6C schematically illustrates substrate 80 having strands 90 attached to each other to form stripe 180 which is simultaneously of consecutively attached as added material 185 to substrate 80. Either or both substrate 80 and tip 110 may be moved to provide continuous addition of material 185. Re-solidification connection point 125 is shown schematically, both for strands 90 attaching to each other and for stripe 180 to substrate 80.

FIGS. 6D and 6E are perspective bottom view and perspective top view, respectively, of feeder 150, strand timing module 151 and tip 110, according to some embodiments of the invention. Heater unit 120 is illustrated at the bottom of the device and may be configured to heat substrate 80, e.g. by hot air convection, and possibly also strands 90. FIG. 6F schematically illustrates tip 110 with heating element 120 configured to liquefy the strand surfaces and optionally liquefy the surface of substrate 80 to provide attachment and monolithic re-solidification of strands 90 to substrate 80. Strand and substrate heating may be carried out by a single heating element (e.g., a laser source) included in unit 120 or by multiple heating elements (two or more laser sources).

FIGS. 7A-7F are high level schematic configurations of attached strands at various spatial configurations 185A-F, according to some embodiments of the invention. individual strands are illustrated as being separate for clarity of the explanation, although they are monolithically attached in the actual manufactured product or part. Any of the spatial configurations may include multiple steps of additive manufacturing of strands. FIG. 7A schematically illustrates a spatial configuration 185A of strands 90 that yields a hanging, bench-like structure. Strands may be added in sequential addition steps utilizing a varying number of strands attached to each other prior to deposition, to provide strength in the horizontal direction. FIG. 7B schematically illustrates a spatial configuration 185B of strands 90 that yields a flange having adjustable fine scale characteristics that are determined according to the specific strand feeding configuration. FIG. 7C schematically illustrates a spatial configuration 185C of strands 90 that yields a complex structure that is nevertheless monolithically attached and has uniform mechanical properties across the structure. The disclosed system 100 and method 300 provide the capability to modify and monitor a highly versatile spatial strand configuration to yield many complex structures. FIG. 7D schematically illustrates a spatial configuration 185D of strands 90 that yields a partially hollow intermediate layer (185D-2, having zigzag-attached strands) between an inner continuous layer and an outer continuous layer, 185D-1 and, respectively. Spatial configuration 185D may be used e.g., to reduce the weight of a produced cylindrical part (see FIG. 2) by intermediate layer 185D-2, while providing required properties of the inner and outer surfaces thereof. FIG. 7E schematically illustrates a spatial configuration 185E of strands 90 that yields an overhang that provide a dome-like structure without requiring any supports as in traditional 3D printing. The mechanical strength results from strands 90 attached to each other prior to their deposition. FIG. 7F schematically illustrates a spatial configuration 185F of flattened strands 90/strips 180 that yields an overhang that provides a dome-like structure. Strips 180 may be produced from attached thin strands or may be received in broad strand form as fed material 91.

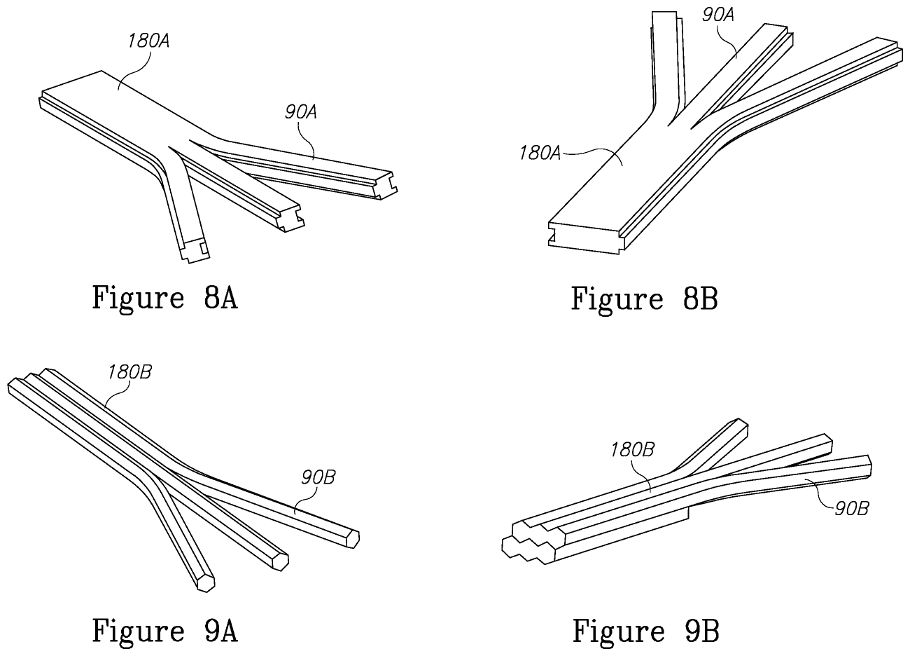

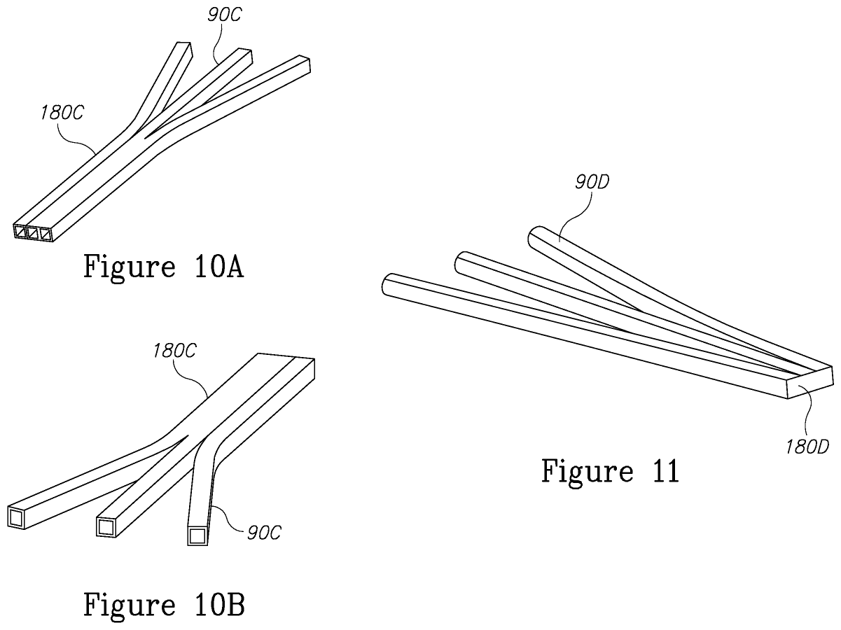

FIGS. 8A-11 are high level schematic illustrations of various types of strands 90 and their attachment, according to some embodiments of the invention. FIGS. 8A and 8B schematically illustrate strands 90A having a complex H-like profile which complement each other upon attaching strands 90A into stripe 180A, the respective protrusions and recesses in the profile supporting the attachment by surface liquefaction. FIGS. 9A and 9B schematically illustrate strands 90B having hexagonal profiles (that may be solid or hollow), which complement lower and upper deposited strands 90B upon attachment into stripe 180B and onto substrate 80 (not shown). FIGS. 10A and 10B schematically illustrate strands 90C having hollow profiles (the outer periphery of the hollow is maintained solid during attachment of strands 90C) providing stripe 180C with hollows that reduce their weight and may enable insertion of wires into the hollows. FIG. 11 schematically illustrates strands 90D having round profiles which are attached to form stripe 180D having a rectangular profile, achieved by the surface melting of strands 90D, possibly under application of some lateral pressure or guidance. The cores of strands 90D are maintained solid during the attachment process to avoid thermal deformation.

Elements from FIGS. 1A and 1B as well as from FIGS. 2-11 may be combined in any operable combination, and the illustration of certain elements in certain figures and not in others merely serves an explanatory purpose and is non-limiting.

FIG. 12 is a high-level flowchart illustrating method 300 of additive manufacturing, according to some embodiments of the invention. The method stages may be carried out with respect to system 100 described above, which may optionally be configured to implement method 300. Method 300 may be partially implemented, with respect to the control processes, by at least one computer processor. Certain embodiments include computer program products including a computer readable storage medium having computer readable program embodied therewith and configured to carry out of the relevant stages of method 300. Stages presented in FIG. 1F, which further illustrates method 300 above, may be combined with stages presented in FIG. 12. Method 300 may include any of the following stages, irrespective of their order.

Method 300 includes receiving, continuously, solid polymer material in form of at least one strand or a plurality of particles (stage 310), heating a surface of the continuously received solid polymer material peripherally to liquefy the surface, using specified heating-related parameters which are selected to maintain a central volume of the continuously received solid polymer material in a solid state (stage 340), optionally selecting heating-related parameters to maintain the center solid (stage 342). Method 300 further includes liquefying a surface of a polymer substrate (stage 350), maintaining the bulk of the substrate solid (stage 352), and attaching the peripherally heated surface of the continuously received solid polymer material to the liquefied surface of the polymer substrate, wherein the attachment to the polymer substrate is achieved by a re-solidification of the liquefied surface to yield monolithic attachment (stage 360). Substrate including a structure that was previously produced by method 300 may be used (stage 354).

Receiving 310 may include receiving continuously, a plurality of solid material strands (stage 312) and attaching 360 may include attaching the plurality of strands to each other, according to a spatial feeding configuration (stage 314), such as a linear arrangement of the strands next to each other (stage 320). Method 300 may further include pressing the strands against each other to enhance the attaching (stage 316). Method 300 may further include feeding the strands at specified angles with respect to each other to enhance the attaching (stage 318). Method 300 may further include controlling feeding parameters of each strand to be received (stage 322) to control the form of the manufactured product and to control the heating period of the strands. Alternatively or complementarily, attaching 360 may include attaching the strands to each other and, simultaneously, attaching the strands to the substrate (stage 366). Alternatively or complementarily, method 300 may include using polymer particles as the solid polymer material (stage 330).

Method 300 may further comprise continuously producing the strands to be received (stage 324), e.g., by extrusion. Method 300 may further include adjusting a cross section of the produced strands according to specified attachment and structural requirements (stage 326) and possibly using hollow strand(s), strands of different solid materials, reinforced strand(s) and strand(s) with additive(s) (stage 328).

Method 300 may further include carrying out attaching 360 with respect to the substrate according to a specified product design (stage 362). In certain embodiments, method 300 may further include pressing the peripherally heated surface of the continuously received solid material against the liquefied surface of the substrate (stage 364).

Method 300 may further comprise optimizing the specified heating-related parameters such as the choice of heat source, adjustment of the heating temperature, the heating duration and the feeding velocity of the solid material (stage 344) and optionally modifying the specified heating-related parameters to determine and control a depth of surface liquefaction with respect to a geometry of the substrate, while maintaining the central volume in a solid state (stage 346). Method 300 may further include continuously controlling a manufacturing process according to method 300 and/or monitoring the attaching in closed loop to control a quality of a manufactured product (stage 372) and optionally modifying the specified heating-related parameters on-the-fly according to the monitored attachment, manufacturing process and controlled quality (stage 374). Method 300 may further include modifying the attaching location (e.g., according to the closed-loop monitoring) to compensate for geometry deviation from a desired parameter such as position, volume, tolerance etc. (stage 376).

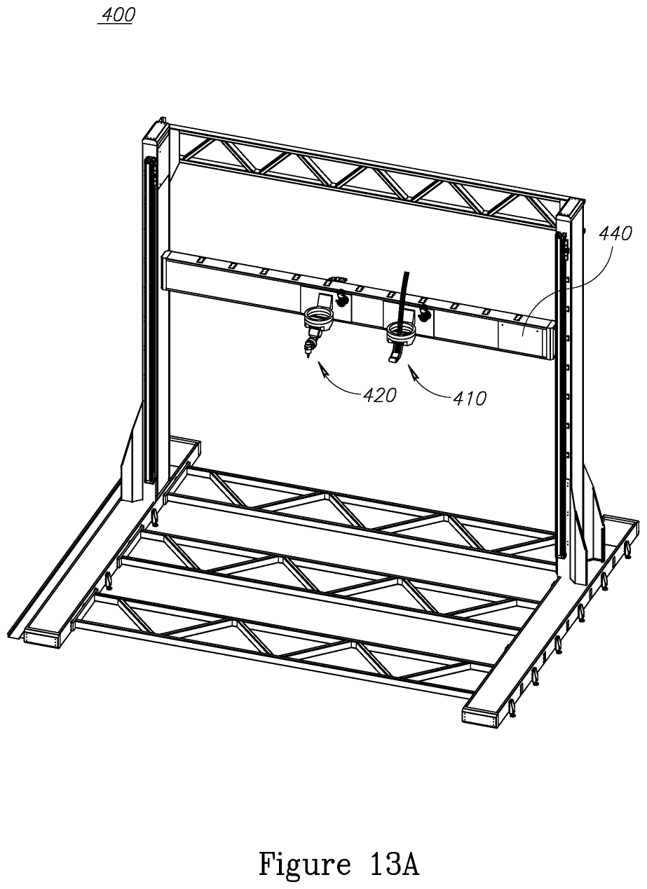

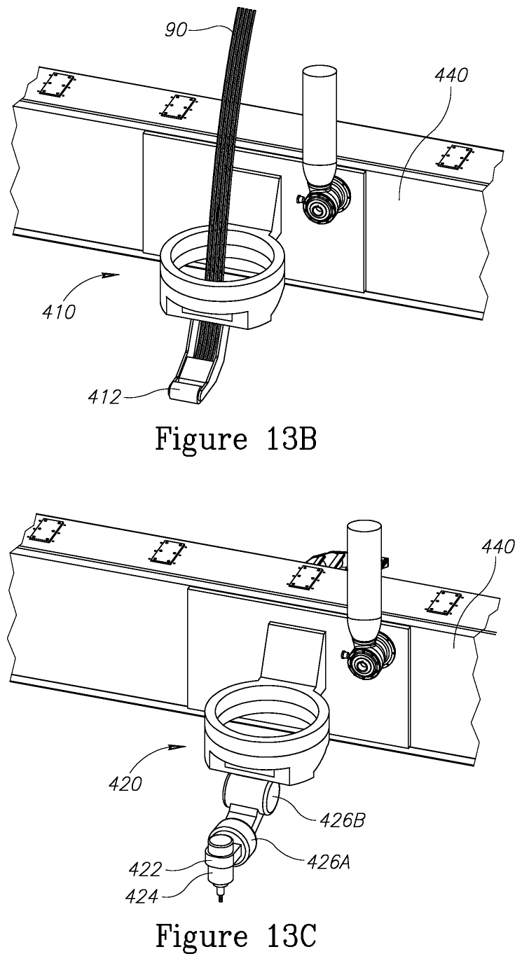

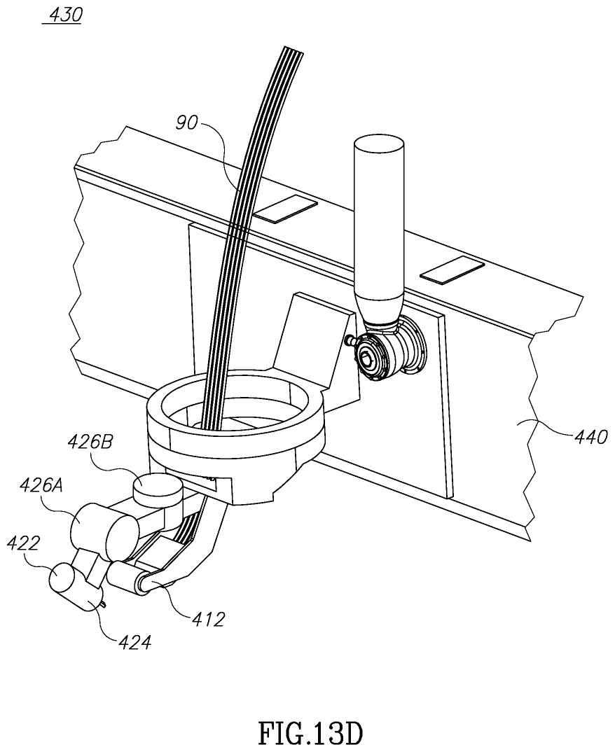

FIG. 13A is a high level schematic illustration of an additive manufacturing system 400 including a printing head 410 and a routing head 420, according to some embodiments of the invention.

System 400 may include a printing head 410 and a routing head 420 coupled to a positioning unit 440. In various embodiments, positioning unit 440 is identical to positioning units 130 as described above with respect to FIGS. 1-6.

FIG. 13B is a high-level schematic illustration of a printing head 410 of an additive manufacturing system 400, according to some embodiments of the invention.

Printing head 410 may be configured to perform polymer additive manufacturing (e.g., as described above with respect to FIGS. 1-13). Printing head 410 may include a tip 412 that may be identical to tips 110 as described above with respect to FIGS. 2 to 6. Printing head 410 may include feeder(s), heating element(s), cutting unit(s) and/or attachment unit(s) that may be identical to feeder(s) 150, heating element(s) 120, cutting unit(s) 170 and attachment unit(s) 135, respectively, as described above with respect to FIGS. 2 to 6.

FIG. 13C is a high level schematic illustration of a routing head 420 of an additive manufacturing system 400, according to some embodiments of the invention. Routing head 420 may be configured to perform on-line processing (e.g., drilling, routing, etc.) of the material (e.g., strands 90 and/or stripes 180, as described above with respect to FIGS. 1 to 11). In various embodiments, routing head 420 is configured to operate simultaneously and/or in a sequence with operation printing head 410. Routing head 420 may include a holder 422 configured to receive and hold a processing tool 424. In various embodiments, processing tool 424 includes a spindle, a drill head, a tapping head, a knife head and/or an ironing head.

Routing head 420 may include rotary axes 426 (e.g., hinges), for example, a first rotary axis 426A and/or a second rotary axis 426B. Rotary axes 426 may be configured to enable orientation and/or positioning of processing tool 424 at a predetermined orientation and/or position with respect to processes material (e.g., strands 90 and/or stripes 180). In some embodiments, a robotic unit (not shown) may be used to position and/or orient processing tool 424.

FIG. 13D is a high-level schematic illustration of a hybrid head 430 of an additive manufacturing system 400, according to some embodiments of the invention.

Hybrid head 430 may include printing head 410 that may include, for example tip 412, feeder(s), heating element(s), cutting unit(s) and/or attachment unit(s) (e.g., as described above with respect to FIG. 13B) and routing head 420 that may include, for example, holder 422, processing tool 424 and/or rotary axes 426 (e.g., as described above with respect to FIG. 13C).

In various embodiments, printing head 410 and/or routing head 420 are detachably coupled to hybrid head 430. For example, at least one of printing head 410 and/or routing head 420 may be detached from hybrid head 430. In various embodiments, orientation and/or position of processing tool 424 (e.g., spindle) of routing head 420 is adjusted with respect to printing head 410 using, for example, rotary axes (e.g., hinges) 426.

Referring back to FIGS. 13A-13D, printing head 410 and routing head 420 may be configured to operate in a sequence with respect to each other. In some embodiments, printing (e.g., addition of material by tip 412 of printing head 410) is performed prior to processing (e.g., routing) of the material. In some embodiments, processing of the material (e.g., routing) by routing head 420 is performed prior to printing (e.g., addition of material) by printing head 410 to, for example, prepare the material for printing.

In various embodiments, printing head 410 and routing head 420 may be configured to operate simultaneously to, for example, complement and/or correct each other. For example, routing head 420 may remove access material while printing head 420 may add material to cover milled areas. In another example, printing head 410 may attach additional layers that may obstruct access to desired areas of substrate 80, while routing head 420 may drill and/or route substrate 80 to enable the access to the desired areas.

In various embodiments, printing head 410 and routing head 420 are mounted on same and/or separate motion axes. In various embodiments, printing head 410 is mounted on a first positioning unit (e.g., positioning unit 440) and routing head 420 is mounted on a second positioning unit (e.g., positioning unit 440), where the first and the second positioning units may be configured to operate simultaneously and/or in a sequence with respect to each other.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which includes one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. An additive manufacturing system comprising:
a feeder configured to continuously feed, two or more solid polymer material strands;
a first guiding unit comprising two or more conduits to continuously receive and guide the two or more solid polymer material strands from the feeder towards a connecting point;
a first laser unit, comprising one or more laser sources, each source is directed to deliver a specified laser beam with respect to adjacent surfaces of two adjacent strands towards the connecting point; and
a first press configured to press the free surfaces, substantially parallel to the adjacent surfaces of the two or more strands to form a continuous solid strip.

2. The additive manufacturing system of claim 1, further comprising:
a second guiding unit configured to continuously direct the continuous solid strip to be attached to one of: a substrate and a previously manufactured continuous solid strip;
a second laser unit, comprising one or more laser sources, each source is directed to deliver a specified laser beam with respect to adjacent surfaces of the continuous solid strip and one of: the substrate and the previously manufactured continuous solid strip; and
a second press configured to press the continuous solid strip and one of the substrate and the previously manufactured continuous solid strip one to the other.

3. (canceled)

4. The additive manufacturing system of claim 1, wherein the one or more laser sources apply laser beams having 700-3500 nm wavelength.

5. The additive manufacturing system of claim 1, wherein the one or more laser sources apply laser beams having 900-1100 nm wavelength.

6. The additive manufacturing system of claim 1, wherein each one of the one or more laser sources applies laser beam at an intensity optimized to melt 20-500 microns of the surfaces of the solid polymer strands.

7. The additive manufacturing system of claim 1, wherein each one of the one or more laser sources applies laser beam at an intensity optimized to melt the adjacent surfaces of the solid polymer strands to a depth of 0.5-25% from a dimension of each strand perpendicular to the adjacent surface.

8. The additive manufacturing system of claim 1, wherein the feeder is configured to continuously feed two or more solid polymer material strands at a feeding velocity optimized to allow the laser beams to melt 20-500 microns of the surface of the solid polymer strands.

9. The additive manufacturing system of claim 1, wherein the feeder is configured to continuously feed the two or more solid polymer material strands at a feeding velocity optimized to allow the laser beams to melt the adjacent surfaces of the solid polymer strands to a depth of 0.5-25% from a dimension of each strand perpendicular to the adjacent surface.

10. (canceled)

11. The additive manufacturing system of claim 1, wherein the two or more conduits are located such that the two or more strands are directed one toward the other at a predetermined angle of 2-80 deg.

12. A method for additive manufacturing comprising:
providing at least two solid polymer strands guided towards a connecting point of adjacent surfaces of each two strands; and
continuously directing and delivering at least one first specified laser beam towards each connecting point, using a first laser unit, comprising one or more laser sources;
melting portions of the adjacent surfaces of each two adjacent strands; and
continuously pressing free surfaces, substantially parallel to the melted adjacent surfaces of the two or more strands, to bond the melted adjacent surfaces to form a solid strip, using a first press.

13. The method of claim 12, wherein providing at least two adjacent strands comprises:
continuously feeding, by a feeder, two or more solid polymer material strands; and
continuously receiving and guiding the two or more solid polymer material strands from the feeder using a first guiding unit comprising two or more conduits.

14. The method of claim 12, wherein providing at least two adjacent strands comprises:
placing a first solid polymer material strand with respect to a second solid polymer material strand.

15. The method of claim 12, further comprising:
continuously directing the continuous solid strip to be attached to a one of: a substrate and previously manufactured continuous solid strip, using a second guiding unit;
directing and delivering at least one second specified laser beam with respect to adjacent surfaces of the continuous solid strip and one of: the substrate and the previously manufactured continuous solid strip, using a second laser unit, comprising one or more laser sources;
melting portions of the adjacent surfaces of the strip and one of: the substrate and the previously manufactured continuous solid strip; and
pressing the continuous solid strip and one of: the substrate and the previously manufactured continuous solid strip, one to the other, using a second press, to form 3D object.

16. (canceled)

17. (canceled)

18. The method of claim 12, wherein a first strand from the at least two strands is made from a first type of polymer and a second strand from the at least two strands is made from a second type of polymer.

19. (canceled)

20. The method of claim 12, wherein melting portions of the adjacent surfaces of each two adjacent strands is to a depth of 0.5-25% from a dimension of each strand perpendicular to the adjacent surface.

21. The method of claim 12, wherein melting the adjacent surfaces of each two adjacent strands is to a depth of 20-500 microns.

22. The method of claim 12, wherein pressing the free surface of the two or more strands to form the solid strip, using the first press is conducted from two sides of the continuous solid strip.

23. The method of claim 15, wherein pressing the continuous solid strip and one of, the substrate and the previously manufactured continuous solid strip, one to another is by applying pressing force on at least one free surface of the continuous solid strip.

24. An additive manufacturing system comprising:
a feeder configured to continuously feed, a solid polymer material strand;
a guiding unit comprising a conduit to continuously direct the solid polymer material strand to be attached to one of: a substrate and a previously provided solid polymer material strand;
a laser unit, comprising one or more laser sources, each source is directed to deliver a specified laser beam towards a connecting point between adjacent surfaces of the solid polymer material strand and one of: the substrate and the previously provided solid polymer material strand; and
a press configured to press at least one free surface, substantially parallel to the adjacent surfaces.

25. (canceled)

26. (canceled)

27. The additive manufacturing system of claim 24, wherein each one of the one or more laser sources applies laser beam at an intensity optimized to melt 20-500 microns of the surface of the solid polymer strand.

28.-41. (canceled)
